(19) United States
(12) Patent Application Publication
(10) Pub. No.: US 2012/0313268 A1
(43) Pub. Date: Dec. 13, 2012

(54) Method for producing an intelligent label, intelligent label and uses thereof, method for preparing solutions in ampoules, solutions and compositions based on conjugated polymers, and electronic device for monitoring radiation doses

(75) Inventors: Rodrigo Fernando Bianchi, Minas Gerais (BR); Thiago Schimitberger, Minas Gerais (BR); Claudia Karina Barbosa De Vasconcelos, Minas Gerais (BR); Giovana Ribeiro Ferreira, Minas Gerais (BR)

(73) Assignees: Rua pompeia, no. 101-11 andar, Bairro Sao Pedro, Belo, Horizonte-MG (BR); UNIVERSIDADE FEDERAL DE OURO PRETO, Minas Gerais (BR)

(21) Appl. No.: 13/512,717

(22) PCT Filed: Nov. 30, 2010
(86) PCT No.: PCT/BR2010/000398

§ 371 Date: Aug. 6, 2012

(30) Foreign Application Priority Data
Nov. 30, 2009 (BR) 014090005289

(51) Int. Cl. C09K 11/06; C09K 11/02; B29D 11/00; C09K 11/59; C09K 11/67; C09K 11/77; C09K 11/08; C09K 11/64

(52) U.S. Cl. 264/1.1; 252/301.35; 252/301.33

(57) ABSTRACT

A method is described for producing an intelligent label and solutions in ampoules, besides compositions based on conjugated polymers for monitoring radiation doses, the label and solutions, in an organic solvent, of (i) an electronic polymer (1-2000 μg/mL) and at least one organic crystal, inorganic crystal or luminescent dye (1-2000 μg/mL), or (ii) a combination of electronic polymers (1-2000 μg/mL), with solutions of said luminescent materials. The film-like label is obtained by drying solutions of luminescent materials on glass plates. The preferred materials are poly(2-methoxy,5-ethyl(2-hexyloxy)-p-phenylenevinylene) (MEH-PPV) as the preferred polymer and [aluminium-tris(8-hydroxyquinoline)] (Alq3) as the preferred organic crystal, besides various organic and inorganic dyes. The label and solutions in ampoules have a large variety of uses, as dosimetres of both ionising and non-ionising radiation, with therapeutic and technological aims, such as foodstuff irradiation in order to delay the ripening process.

### FIELD OF THE INVENTION

The present invention relates to the field of radiation labels and dosimeters, more specifically, to a label and solutions based on systems of luminescent polymer materials for use in the medical, hospital and therapeutic fields and for sanitary, phytosanitary, technological, food and aesthetic purposes, wherein the color change allows the application of the same in radiation therapy and in fields such as sunless tanning, treatments for vitiligo and in the real-time monitoring and controlling of exposure rates of individuals to solar radiation and of jaundiced neonates exposed to phototherapy.

### BACKGROUND OF THE INVENTION

Until the mid-70's, polymers were taken as materials having high electrical insulation capability and versatile mechanical properties. However, after obtaining a high electrical conductivity polyacetylene in 1977, polymers have become much more evidently “technological materials”. Since then, it has become possible to reversibly change the electrical conductivity of such materials (from very low—insulating—to typical metal values). In the following years until today, tens of other polymers with a semiconductor/conductor behavior similar to that observed in the polyacetylene have been synthesized, which are currently used as active elements in diodes, chemical sensors and transistors. Among these polymers, those which have been more widely studied include polyaniline, polypyrrole, polythiophene and poly(p-phenylene).

Below, the names and structural formulae of some of these polymers are shown.

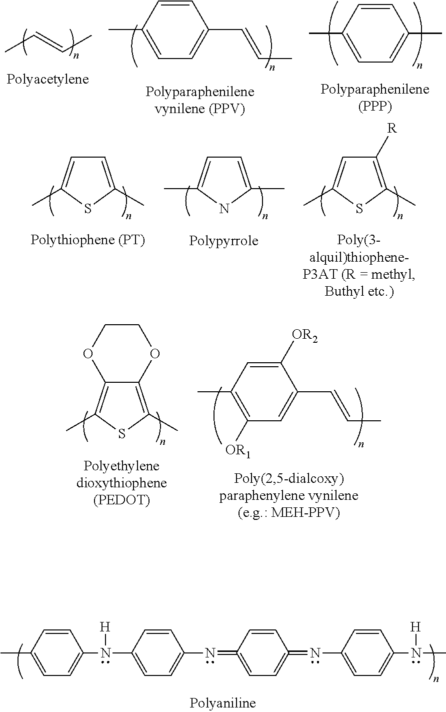

The conjugated polymers, thanks to features thereof such as electronic conductivity and good mechanical properties, further have alternation between simple and double carbon-carbon bonds (sometimes, carbon-nitrogen bonds) in the main polymer chains thereof. Simple bonds are referred to as σ bonds, while double bonds comprise a σ bond and a π bond. Moreover, conjugated polymers comprise σ bonds formed by overlapping sp² hybrid orbitals. The π bonds, in turn, are formed by overlapping pz orbitals between adjacent carbon (or nitrogen) atoms. These bonds tend to form weak non-located bonds, unlike the σ bonds, which are responsible for the rigidity of the covalent bonds located between the two adjacent nuclei. Throughout the conjugated polymers main chain, at least one path can be identified where there is a sequence of both simple and double repetitive bonds between adjacent carbons as seen in the chemical structures shown in the formulae above.

In 1990, following the discovery of the luminescent properties of the conjugated polymer poly(p-phenylenevinylene) (PPV), see the article by Burroughes J. H., et al., Light-emitting diodes based on conjugated polymers, Nature 347, 539 (1990), such materials have begun to be widely used as active elements in light-emitting devices (polymer light-emitting diodes—PLEDs), having numerous advantages over conventional devices, see the British CDT company website (www.cdtltd.co.uk), as well as the Phillips company website (www.phillips.com), such as low production cost, easiness of processing, flexibility, capability of construction in great panels etc.

In the optoelectronic field, in turn, prototypes of displays for monitors, televisions, mobile phones, DVD's and videocassettes with a wide angle of view (165°) already exist.

However, the photooxidation phenomenon in polymer materials is one of the main causes in the use restriction of such displays, see Fahlman M., Salaneck W. R., (2002), Surf Sci. 500, 904. While the efficiency of such devices achieves high values, the process of photooxidation is one of the main reasons for their quick reduction, see the article by Corcoran N. et al., (2003), Appl. Phys. Let. 82, 2, 299. Such phenomenon is minimized when the devices are processed in oxygen-free environments, see Hadziioannou G., Hutten P. F. V. (1999), Semiconducting polymers, Willey-VCH.

On the other hand, while, in the display technology viewpoint, the photooxidation phenomenon limits the commercialization of such systems, such phenomenon arises as an important feature for the development of new electronic devices, wherein the variation of the optical and electrical properties of these polymers upon exposure to different radiation sources and doses turns out as an aspect of great scientific and technological interest, see Bonin J. F., Silva E. A. B, Nicolucci P., Netto T. G., Graeff C. F. O., Bianchi R. F., (2005), Low dose ionizing radiation detection using conjugated polymers, Appl. Phys. Let. 86, 131902; Ferreira, G. R., de Vasconcelos, C. K. B., Bianchi, R. F., Design and characterization of a novel indicator dosimeter for blue-light radiation, Medical Physics, v. 36, p. 642-644, 2009; P. A; S., Autreto, Vasconcelos, C. K. B., M. Z. Flores, D. S. Galvão, Bianchi, R. F., MEH-PPV Based Blue-light Dosimeter for Hyperbilirubinemia Treatment, Materials Research Society Symposium Proceedings, v. 1133, p. 1133-AA07-14-1133-AA07-18, 2009; de Vasconcelos, C. K. B., Bianchi, R. F., A blue-light dosimeter which indicates the dose accumulation by a multicoloured change of photodegraded polymer, Sensors and Actuators, B. Chemical, p. 30-34, 2009.

In relation to the production of dosimeters, such remark is very promising, because the radiation absorbed by the polymer material can be detected from the production of a simple apparatus, such as a colorimeter, which would have, as basic operation principle, the correlation between the intensity and the shape of the absorption spectra in the UV-VIS region and the emission with the dose-electrical response curve of a photodetector device or the like.

Even more interesting is that the absorption spectra in the visible region of MEH-PPV shows great variation either when the polymer is exposed to low doses of ionising radiation or not, which opens to the possibility of producing great potential dosimeters for use in the medical field, as well as for controlling the treatment of neonatal hyperbilirubinemia, see M. Jeffrey Maisels and A. F. McDonagh, Phototherapy for neonatal jaundice, The New England Journal of Medicine, 358:9 (2008), or the exposure to radiation for sunless tanning purposes, see Chaves A., Shellard R. C, (2005) in Pensando o Futuro-O desenvolvimento da Física e sua inserção na vida social e economica do país, Sociedade Brasileira de Física, p. 166-167, or even in the environmental field in relation to work security, wherein there is a critical need for controlling the exposure rates of civil and rural workers to UV radiation, see Mattos R, O risco da exposição ao sol na construção civil, at http://www.sindusconpa.org.br/noticias/18082004.asp#.

Recent examples of application of luminescent polymers as active elements in radiation sensors are found in the hospital field, see the article by J. F. Bonin et al. mentioned herein above, as real-time monitoring dosimeters for low doses of gamma radiation particularly used in procedures for sterilizing blood bags for transfusion in oncologic patients (cobalt therapy). In all these cases, there is a need for more accurate systems for monitoring the radiation intensities and doses with real-time response.

Such features can be found in the investigation of changes in the optical properties of luminescent polymers when exposed to different radiation sources. However, despite all this technological appeal, a few polymers have been studied for this purpose. This opens perspectives not only for scientific studies of such materials, but, above all, for the production and development of new systems for controlling and monitoring radiation intensities and doses used in measured fields, which are, therefore, of economic and social interest.

In short, studying the behavior of the optical properties of luminescent polymers when exposed to different radiation sources and doses provides a real opportunity for developing new organic devices wherein the degradation of the polymer layer, in such case, becomes one of the main advantages.

The World Health Organization (WHO) defines as non-ionising radiation a frequency range between 0 and 300 GHz, including ultrasound (>20 KHz), infrasound (<20 KHz), static electric and magnetic fields, extremely low frequency fields, RF (such as microwaves), infrared, visible and ultraviolet radiation.

The increasing number of studies in the field of non-ionising radiation finds justification for the damages caused to human health due to exposure to this kind of radiation, as well as for the phototherapy treatment, of neonatal hyperbilirubinemia, often used in the daily clinical practice in Neonatology.

Hyperbilirubinemia or jaundice is one of the neonatal pathologies that have been receiving a lot of attention in the last years. According to the Brazilian Society of Pediatrics, just in Brazil, every year, about 1.5 million newborns develop jaundice already in its first days and, among these, about 250,000 in serious condition with the risk of neurotoxicity, Kernicterus or death. Characterized by a high concentration of bilirubin in the blood, there are, however, specific and effective treatments for controlling this disease, such as blue-light phototherapy, exchange transfusion and pharmacological therapy, the first of these being simple and widespread in hospitals for producing photochemical reactions which change the bilirubin molecular structure, thus reducing its toxicity. Nevertheless, in relation to phototherapy, the use of inappropriate or improper lightning systems is disclosed, see the Ph. D. thesis by Jose Pucci Caly, “Estudo e avaliação da radiometría no tratamento fototerápico da hiperbilirrubinemía neonatal”, Instituto de Pesquisas Energéticas e Nucleares—USP. Referring to the bad positioning of newborns in front of the light source as a factor which reduces the effectiveness of this treatment, see M. Jeffrey Maisels and A. F. McDonagh, Phototherapy for neonatal jaundice, The New England Journal of Medicine, 358:9 (2008).

It is still needed to take into account that the treatment for jaundice depends on the regular evaluation of total serum bilirubin. However, also according to recent researches, when newborns are exposed to stress or painful procedures, such as the need to determine the serum bilirubin level or the exposure to intense light—two procedures related to the phototherapy treatment—, they can have serious issues in the future, such as great sensibility to pain and pain response to non-painful stimuli, besides irritability, agitation, anxiety, difficulty in facing new situations and learning problems, see Revista Época 532, Jul. 21, 2008. Thus, a new viable alternative in order to improve the effectiveness of phototherapy, and therefore eliminate possible operational problems of the treatment, consists in using sensors for monitoring the accumulation of radiation dose delivered to jaundiced newborns. The use of such labels would make it possible to evaluate the equivalence of delivered and prescribed doses for controlling said disease in each neonate, thus ensuring the accuracy of the treatment and, therefore, avoiding underdosage. Unfortunately, to date, there are no standard methods or equipment for this purpose disclosed in the literature, see M. Jeffrey Maisels and A. F. McDonagh, Phototherapy for neonatal jaundice, The New England Journal of Medicine, 358:9 (2008) and the thesis by Jose Pucci Caly mentioned herein above.

E. A. B. Silva et al., in the article Low dose ionizing radiation detection using conjugated polymers, Appl. Phys. Lett. 86, 131902 (2005), describe the effect of gamma radiation on the optical properties of poly[2-methoxy-5-(2′-ethylhexyloxy)-p-phenylenevinylene] (MEH-PPV). Samples are irradiated at room temperature at different doses from 0 Gy to 152 Gy using a ⁶⁰Co gamma ray source. For thin films, significant variations in the UV-visible spectra were noticed only for high doses (>1 kGy). In solution, displacements in the absorption peaks are noticed for low doses (<10 Gy), which depend directly on the dose. Such displacements are explained by the reduction in the conjugation of the main polymer chain. The results indicate that MEH-PPV in solution can be used as an appropriate dosimeter for medical and hospital applications.

The Brazilian application publication PI 0600986-7 provides the use of MEH-PPV solutions as an ionising radiation dosimeter. MEH-PPV solutions in an aromatic organic solvent, or in other chlorinated organic solvents, are contained in ampoules sealed by a threaded cap and submitted to radiation. Besides medical application, these ampoules can be used for determining irradiation doses in food and flowers. Such dosimeter differs from the present label and other objects of this application in that it uses only one conjugated polymer, in addition to not foreseeing the production of thin films.

The Brazilian application publication PI 0700497A refers to a non-ionising radiation dosimeter based on systems of conjugated, luminescent polymer materials for use in the medical field, such as for controlling radiation exposure to neonates during phototherapy in order to reduce serum bilirubin levels. Such dosimeter uses MEH-PPV in solution as the only photosensible material. The production of thin films for use as intelligent labels is not mentioned.

U.S. Pat. No. 3,980,696 provides a photodosimeter label as a film for measuring radiation during phototherapy in the treatment of hyperbilirubinemia. Such label comprises an uniform thickness thin film comprising dissolved bilirubin bonded to a polymer base, said bilirubin substantially being just the IX-alpha isomer of the same at enough concentration to cause a detectable variation in the optical density of said film due to exposure to light having a wavelength of about 425-500 nm; and a optically transparent substrate which is impermeable to oxygen and which encloses said film, thus preventing oxygen from contacting said film, while the light that reaches the film causes the photodecomposition of the bilirubin without turning it into biliverdin. The polymer base is composed of acrylic glass with melanin, polycarbonate, phenoxy, polystyrene, styrene and poly(methyl methacrylate) (PMMA) only or EVA.

Therefore, there is still a need for an intelligent label and a dosimeter based on conjugated polymers for monitoring non-ionising and ionising radiation doses, said label, method for producing it, compositions and use thereof, as well as said dosimeter, being described and claimed in the present application.

### SUMMARY OF THE INVENTION

Generally, a method for producing an intelligent label based on conjugated polymers for monitoring radiation doses according to the present invention comprises the following steps:

a) in the absence of light and at room temperature, mixing solutions, in an organic solvent, of i) an electronic polymer (1-2000 μg/ml) and at least one organic crystal, inorganic crystal or luminescent dye (1-2000 μg/ml), or ii) a combination of electronic polymers (1-2000 μg/ml), thereby obtaining solutions of said luminescent materials;

b) pouring the solutions of (a) on glass substrates in order to obtain self-sustaining films by the casting method;

c) vaporizing the solvent by any method; and

d) separating and retrieving the intelligent label as a luminescent film for various applications.

Alternatively, the method of the present invention for producing an intelligent label based on conjugated polymers for monitoring radiation doses comprises:

a) preparing inert polymer matrix solutions in an organic solvent at a concentration of at least 1 μg/mL to 50 mg/mL;

b) in the absence of light and at room temperature, mixing, in a volumetric ratio of at least 5:1 to 50:1, the solution obtained in (a) with solutions, in an organic solvent, of i) an electronic polymer (1-2000 μg/ml) and at least one organic crystal, inorganic crystal or luminescent dye (1-2000 μg/ml), or ii) a combination of two electronic polymers (1-2000 μg/ml), thereby obtaining solutions of the luminescent materials in an inert matrix;

c) pouring the solutions of (b) on glass substrates in order to obtain self-sustaining films by the casting method;

d) vaporizing the solvent by any method; and

e) separating and retrieving the intelligent label as a luminescent film for various applications.

Still alternatively, useful solutions such as a dosimeter according to the present invention comprise:

a) in the absence of light and at room temperature, mixing solutions, in an organic solvent, of i) an electronic polymer (1-2000 μg/ml) and at least one organic crystal, inorganic crystal or luminescent dye (1-2000 μg/ml), or ii) a combination of two electronic polymers (1-2000 μg/ml), thereby obtaining solutions of the luminescent materials in an organic solvent;

b) moving the solutions of (a) to glass ampoules either amphoterically sealed or not and keeping the same away from light; and

c) stocking the dosimeter ampoules for use in various applications.

A composition of an inert polymer matrix of conjugated polymers for obtaining said intelligent label as a luminescent film according to the method above comprises:

a) 0% to 99.9% by weight of an inert polymer matrix in an organic solvent at a concentration of at least 1 μ/mL to 10 mg/mL, said matrix being combined to

b) a combination of solutions in an organic solvent comprising i) 0.1% to 99.9% by weight of an electronic polymer and at least 0.1% to 99.9% by weight of a crystal, inorganic crystal or luminescent dye or ii) a combination in any ratio of two electronic polymers, provided that the degradation rates of the same due to radiation and/or that the emission bands of both polymers are different.

The intelligent label comprises the product obtained after pouring the composition of the present invention on a smooth surface and retrieving the label after drying the solvent.

Alternatively, the product comprises the sealed glass ampoule containing solutions of the luminescent material away from light ready for use in various applications.

The operation of the intelligent label or solutions in ampoules comprises exposing the product to radiation at a wavelength in the range of UV-Visible and monitoring the color and absorption, photoemission and photoexcitation spectra of the same or of the structural changes due to the radiation dose delivered to the individuals or newborns.

Still, the operation comprises exposing the flexible film product or solutions in ampoules to gamma radiation and monitoring the color and absorption, photoemission and photoexcitation spectra of the same or of the structural changes due to the radiation dose delivered to the individuals or oncologic patients submitted to the radiation therapy.

In a further alternative embodiment, the operation comprises exposing the flexible film product or solutions in ampoules to X-rays and monitoring the color and the absorption, photoemission and photoexcitation spectra of the same or of the structural changes due to the radiation dose delivered to the individuals or oncologic patients submitted to radiation therapy.

In a further alternative embodiment, the operation comprises exposing the flexible film product or solutions in ampoules to beta rays and monitoring the color and the absorption, photoemission and photoexcitation spectra of the same or of the structural changes due to the radiation dose delivered to the individuals or oncologic patients submitted to radiation therapy.

In a further alternative embodiment, the operation comprises exposing the flexible film product or solutions in ampoules to electron beams and monitoring the color and the absorption, photoemission and photoexcitation spectra of said film or solutions in ampoules or of the structural changes due to the radiation dose delivered to the individuals or oncologic patients submitted to radiation therapy.

The labels and solutions in ampoules equally find application in the calibration of therapeutic beams used in radiation therapy.

Thus, in a further alternative embodiment, the operation comprises exposing the flexible film product or solutions in ampoules to ionising radiations employed in radiation therapy (gamma, beta, X-rays or electron beams), monitoring the color and the absorption, photoemission and photoexcitation spectra of said film or solutions in ampoules or of the structural changes due to the delivered radiation dose, and calibrating the therapeutic beams according to this dose.

In a further alternative embodiment, the operation comprises exposing the flexible film product or solutions in ampoules to UV radiation employed for sanitary and phytosanitary purposes, and monitoring the color and the absorption, photoemission and photoexcitation spectra of said film or solutions in ampoules or of the structural changes due to the delivered radiation dose.

In a further alternative embodiment, the operation comprises exposing the flexible film product or solutions in ampoules to ionising radiation (gamma rays, X rays, electron beams) employed to food in order to pasteurize products, sterilize products and delay the ripening process of fruits and vegetables, and monitoring the color and the absorption, photoemission and photoexcitation spectra of said film or solutions in ampoules or of the structural changes due to the delivered radiation dose.

An alternative to the method of making the product described above as an ampoule containing solutions of electronic polymer materials and an organic crystal, inorganic crystal or dye or two organic polymers in any ratio as a solution contained in glass ampoules follows the operation mode described in the dosimeter of PI 0700497.

Accordingly, it can be noted that the operation principle of the intelligent label, either as a film or ampoule containing solutions of luminescent materials, involves the use of the same in order to monitoring both ionising and non-ionising radiation doses for a wide range of applications.

In addition, the electronic device according to the invention is capable of indicating change in color and emission of the polymer system by means of a colorimeter-like device which allows identifying the color and the photoemission of the system by means of:

a) an excitation light source with an emission spectrum within the absorption band of the luminescent materials, including blue or purple LED;

b) a luminescent system based on polymer material for being excited by the proper light source; and

c) at least one photodiode, or similar light-capturing device(s), either having optical filters or not, selected within the radiation range of the visible spectrum, including blue, green and red, capable of converting, by means of a microcontroller, the light transmitted and emitted by the luminescent system based on polymer material in voltage, current or electrical resistance, wherein it is possible to either correlate the optical changes in the radiated luminescent system or not with the radiation dose absorbed by the same by means of a display or computer.

Thus, the present invention provides a method for producing an intelligent label based on electronic polymers and organic crystals, inorganic crystals or luminescent dyes or on two different luminescent polymers combined in any ratio, which are dissolved in an inert polymeric matrix.

Alternatively, the method for producing an intelligent label as a film based on solutions of the luminescent components involves forming said film in the absence of an inert polymer matrix.

Still, the present invention provides a method for producing an intelligent label as a film or ampoule based on a pair of luminescent compounds which have degradation rates and/or emission maximums different from one another, such as a red emitter and a blue emitter.

The present invention further provides a composition based on an electronic polymer and at least one organic crystal, inorganic crystal or luminescent dye or two different luminescent polymers in any given ratio having degradation rates and/or emission maximums different from one another which are combined in order to form an inert polymer matrix.

Alternatively, the composition of the present invention comprises only the solutions of the luminescent compounds in an organic solvent, in the absence of an inert polymer matrix, the composition being formed as a film or kept in ampoules away from light.

The present invention further provides an intelligent label based on conjugated polymers as a thin film for use in order to monitor the exposure of radiation to neonates submitted to phototherapy for treating hyperbilirubinemia.

The present invention provides an intelligent label as a thin film in various shapes, including child-like shapes, to be fixed close to a newborn, in diapers, eye patches etc., by means of double sided self-adhesive strip.

The present invention provides an intelligent label as a thin film which is alternatively printed or disposed, by silk screen techniques or the like, in a piece of clothing, diapers., eye patches etc.

The present invention further provides an intelligent label based on conjugated polymers for monitoring the radiation deriving from sunless tanning machines.

The present invention further provides an intelligent label based on conjugated polymers for monitoring the radiation deriving from equipment intended for the treatment of vitiligo.

The present invention additionally provides an intelligent label based on conjugated polymers for monitoring soldiers and civil or rural workers who are exposed to solar radiation during short or long time periods.

The present invention additionally provides an intelligent label based on conjugated polymers for monitoring soldiers and civil or rural workers who are exposed to UV radiation during short or long time periods.

The present invention further provides an intelligent label based on conjugated polymers for monitoring individuals who are exposed to non-ionising radiation for therapeutic purposes.

The present invention further provides a solution based on conjugated polymers for monitoring individuals who are exposed to ionising radiation for therapeutic purposes.

The present invention additionally provides an intelligent label based on conjugated polymers to be used in connection with body parts of an individual in order to evaluate the effective or equivalent radiation dose for a certain time period.

The present invention further provides an intelligent label based on conjugated polymers for monitoring food exposed to ionising radiation for sanitary, phytosanitary and/or technological purposes.

The present invention further provides a solution based on conjugated polymers for monitoring flowers exposed to ionising radiation for commercial purposes.

The present invention further provides films based on conjugated polymers for monitoring flowers exposed non-ionising radiation for commercial purposes.

The present invention further provides a solution based on conjugated polymers for monitoring food exposed to non-ionising radiation for sanitary, phytosanitary and/or technological purposes.

The present invention further provides a dosimeter which is capable of identifying changes in the optical and structural properties of polymers.

The present invention further provides an intelligent label and a dosimeter, the fluorescent properties of which are dramatically changed when exposed to blue-light radiation or to other sources used in hospitals for phototherapy treatments.

The present invention also provides a radiation dose indicator type of label for evaluating radiometry in the phototherapy treatment of neonatal hyperbilirubinemia.

The present invention also provides a radiation dose indicator type of label for evaluating radiometry for sanitary, phytosanitary and/or technological purposes.

### BRIEF DESCRIPTION OF THE DRAWINGS

FIG. 1 shows the absorption and fluorescence spectra obtained from raw solutions of a) MEH-PPV, b) Alq3, and c) MEH-PPV/Alq3.

FIG. 2 shows the absorption and fluorescence spectra obtained from MEH-PPV/Alq3 solutions for different times of exposure to blue light.

FIG. 3 shows absorption and emission spectra of MEH-PPV (250 μg/mL) in chloroform solution at 417 nm excitation.

FIG. 4 shows absorption and emission spectra of Alq3 (500 μg/mL) in chloroform solution at 417 nm excitation.

FIG. 5 shows spectra of MEH-PPV and Alq3 in chloroform showing the absorption of MEH-PPV and the emission of Alq3 before exposure to radiation.

FIG. 6 shows (a) a fluorescence spectrum and (b) a chromaticity diagram for raw MEH-PPV/Alq3 solutions exposed during 120, 240 and 480 min to blue light (40 W/cm²/nm).

FIG. 7 shows a color diagram obtained from pictures of the solutions showing a) reflected colors; and b) emitted colors as a function of the radiation exposure time of solutions having 250 μg/mL of MEH-PPV in chloroform and varying mass of Alq3.

FIG. 8 shows a chromaticity diagram showing the changes in the reflected color throughout the radiation exposure of MEH-PPV/Alq3 solutions having a mass ratio of (a) 1/1; (b) 1/2; (c) 1/3; and (d) 1/4 of MEH-PPV/Alq3. The results are obtained from the solutions shown in FIG. 7.

FIG. 9 shows a chromaticity diagram showing the changes in the emitted color throughout the radiation exposure of MEH-PPV/Alq3 solutions having a mass ratio of (a) 1/1; (b) 1/2; (c) 1/3; and (d) 1/4 of MEH-PPV/Alq3. The results are obtained from the solutions presented in FIG. 7.

FIG. 10 shows a picture in (a) and a chromaticity diagram in (b) showing the color change of the emitted radiation for flexible films based on PS/MEH-PPV/Alq3 before (emission of red light) and after (emission of green light) exposure to blue radiation.

FIG. 11 shows a schematic flow chart of an electronic device of the invention comprising a luminescent polymer, a blue light-emitting LED and a photodiode.

FIG. 12 shows an alternative layout of the electronic device of the invention, comprising two photodiodes and other components such as in the device of FIG. 11.

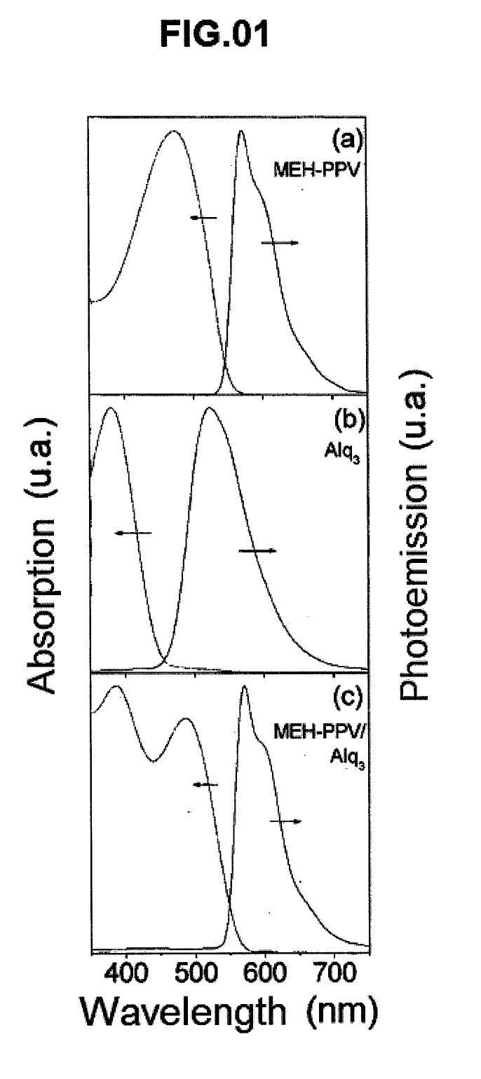

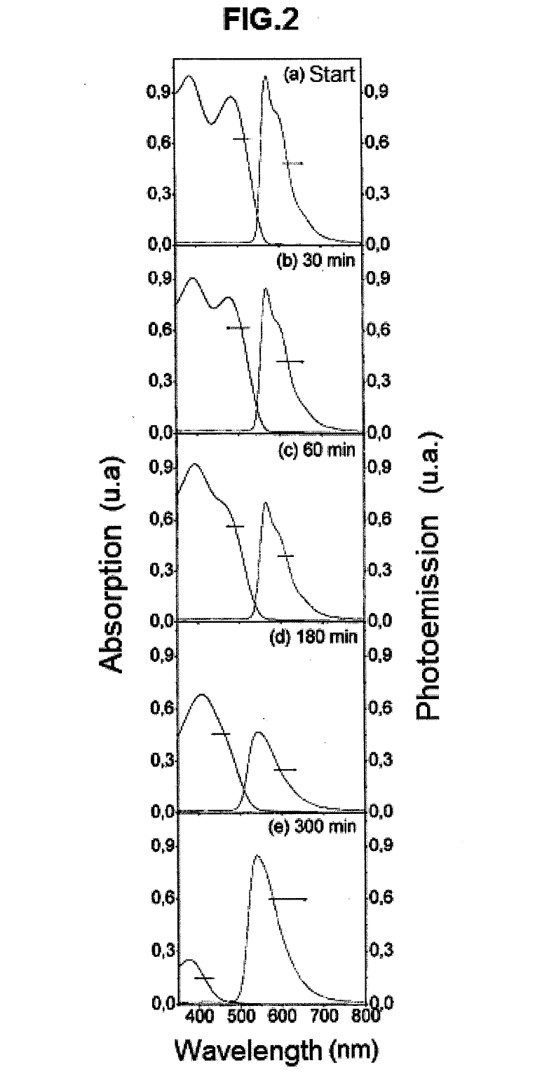

### DETAILED DESCRIPTION OF THE EMBODIMENTS OF THE INVENTION

The intelligent label as a film, the dosimeter with solutions of the materials in ampoules, the compositions and the electronic device of the present invention for monitoring exposure to non-ionising radiation are based on luminescent polymers.

Thus, a first aspect of the invention relates to an intelligent label as a flexible film for monitoring exposure to radiation.

A second aspect of the invention relates to a radiation dosimeter based on MEH-PPV and Alq3 solutions in chloroform inside glass ampoules covered in dark latex paint, the capillary ends of which are either amphoterically sealed or not in order to prevent the solvent from evaporating and to protect the solutions from exposure to radiation.

The operation principle of such dosimeter is similar to that of the films based on the same luminescent materials and, obviously, finds the same wide range of applications.

A third aspect of the invention relates to the intelligent label product as a film obtained by drying the solvent in which the luminescent materials of the composition are dissolved, either in the presence of an inert polymer matrix or in the absence of such matrix.

A fourth aspect of the invention relates to a composition of luminescent materials which is useful for producing films and solutions in ampoules for use as dosimeters in a variety of applications, both for exposure to ionising and non-ionising radiation.

Still, a fifth aspect of the invention relates to an electronic device for monitoring exposure to radiation.

The various aspects of the invention are disclosed in details in the following description.

For making these products, a compound is a light-emitting polymer (LEP).

Useful for the present invention are LEPs of the classes of cyano-polyphenylene vinylene (CN-PPV) polymers selected from poly(2,5-di(hexyloxy)cyanoterephthalylidene, poly(2,5-di(octyloxy)cyanoterephthalylidene), poly(2,5-di(3,7-dimethyloctyloxy)cyanoterephthalylidene, poly(5-(2-ethylhexyloxy)-2-methoxy-cyanoterephthalylidene); nitrogenated polymers selected from poly(2,5-pyridine) and poly(3,5-pyridine); poly(fluorenylene-ethynylene) (PFE) polymers selected from poly(9,9-dioctylfluorenyl-2,7-ylene-ethynylene), poly[9,9-di(3′,7′-dimethyloctyl)fluoren-2,7-ylene-ethynylene], poly[9,9-di(2′-ethylhexyl)fluoren-2,7-ylene-ethynylene], poly[9,9-d]dodecylfluoroenyl-2,7-ylene-ethylnylene]; poly(phenylene-ethynylene) (PPE) polymers selected from poly(2,5-di(3′,7′-dimethyloctyl)phenylene-1,4-ethynylene), poly(2,5-dicyclohexylphenylene-1,4-ethynylene), poly(2,5-di(2′-ethylhexyl)-1,4-ethynylene), poly(2,5-didodecylphenylene-1,4-ethynylene) and poly(2,5-dioctylphenylene-1,4-ethylene); polyfluorene (PFO) polymers and copolymers selected from poly(9,9-di-n-dodecylfluorenyl-2,7-diyl), poly(9,9-di-n-hexylfluorenyl-2,7-diyl), poly(9,9-di-n-octylfluorenyl-2,7-diyl), poly(9,9-n-dihexyl-2,7-fluorene-alt-9-phenyl-3,6-carbazole), poly[(9,9-di-n-octylfluorenyl-2,7-diyl)-alt-(benzo[2,1,3]thiadiazole-4,8-diyl)], poly[(9,9-dihexylfluoren-2,7-diyl)-alt-(2,5-dimethyl-1,4-phenylene)], poly[(9,9-dihexylfluoren-2,7-diyl)-co-(9-ethylcarbazole-2,7-diyl)], poly[(9,9-dihexylfluoren-2,7-diyl)-co-(antracen-9,10-diyl)], poly[(9,9-dioctylfluorenyl-2,7-diyl)-co-bithiophene] 99.9%, poly[9,9-bis-(2-ethylhexyl)-9H-fluorene-2,7-diyl]; polyfluorene-vinylene (PFV) copolymers selected from poly((9,9-dihexyl-9H-fluorene-2,7-vinylene)-co-(1-methoxy-4-(2-ethylhexyloxy)-2,5-phenylenevinylene)), 90:10 molar ratio, poly((9,9-dihexyl-9H-fluorene-2,7-vinylene)-co-(1-methoxy-4-(2-ethylhexyloxy)-2,5-phenylene-vinylene)), 95:5 molar ratio, poly(9,9-di-(2-ethylhexyl)-9H-fluorene-2,7-vinylene), poly(9,9-di-n-hexylfluorenyl-2,7-vinylene), poly[(9,9-di-(2-ethylhexyl)-9H-fluorene-2,7-vinylene)-co-(1-methoxy-4-(2-ethylhexyloxy)-2,5-phenylene-vinylene)] (90:10 molar ratio), poly[(9,9-di-(2-ethylhexyl)-9H-fluorene-2,7-vinylene)-co-(1-methoxy-4-(2-ethylhexyloxy)-2,5-phenylene-vinylene)] (95:5 molar ratio), poly[9-(2-ethylhexyl)-3,6-carbazolevinylene-alt-2,6-naphtalenevinylene; polyphenylenevinylene (PPV) polymers and copolymers selected from poly(1-methoxy-4-(3-propyloxy-heptaisobutyl-PSS)-2,5-phenylenevinylene)-co-(1-methoxy-4-(2-ethylhexyloxy)-2,5-phenylenevinylene) (60:40), poly(1-methoxy-4-(O-disperse red))-2,5-phenylenevinylene, poly(2,5-bis(1,4,7,10-tetraoxaundecyl)-1,4-phenylenevinylene), poly(2,5-dihexyloxy-1,4-phenylenevinylene), poly(2,5-dioctyl-1,4-phenylenevinylene), poly(2,6-naphtalenevinylene), poly(p-xylene tetrahydrothiophenium chloride) as a 0.25% by weight solution in H₂O, film of poly(p-xylene tetrahydrothiophenium) chloride, poly[(m-phenylenevinylene)-alt-(2,5-dyhexyloxy-p-phenylenevinylene)], poly[(m-phenylenevinylene)-alt-(2-methoxy-5-(2-ethylhexyloxy)-p-phenylenevinylene)], poly[(m-phenylenevinylene)-alt-(2-methoxy-5-octyloxy-p-phenylenevinylene)], poly[(m-phenylenevinylene)-co-(2,5-dioctoxy-p-phenylenevinylene)], poly[(o-phenylenevinylene)-alt-(2-methoxy-5-(2-ethylhexyloxy)-p-phenylenevinylene)], poly[(p-phenylenevinylene)-alt-(2-methoxy-5-(2-ethylhexyloxy)-p-phenylenevinylene)], poly[1-methoxy-4-(3-propyloxy-heptaisobutyl-PSS)-2,5-phenylenevinylene], poly[1-methoxy-4-(3-propyloxy-heptaisobutyl-PSS)-2,5-phenylenevinylene]-co-[1-methoxy-4-(2-ethylhexyloxy)-2,5-phenylenevinylene] (30:70), poly[2,5bis(3′,7′-dimethyloctyloxy)-1,4-phenylenevinylene], poly[2,5-bisoctyloxy)-1,4-phenylenevinylene], poly[2-(2′,5′-bis(2″-ethylhexyloxy)phenyl)-1,4-phenylenevinylene], poly[2-methoxy-5-(2-ethylhexyloxy)-1,4-phenylenevinylene] Mₙ 150,000-250,000, poly[2-methoxy-5-(2-ethylhexyloxy)-1,4-phenylenevinylene] Mₙ 40,000-70,000, poly[2-methoxy-5-(2-ethylhexyloxy)-1,4-phenylenevinylene] Mₙ 70,000-100,000, potassium salt in a 0.25% by weight solution in H₂O of poly[2-methoxy-5-(3′,7′-dimethyloctyloxy)-1,4-phenylenevinylene], potassium salt in a solution of poly[5-methoxy-2-(3-sulfopropoxy)-1,4-phenylenevinylene], poly[tris(2,5-bis(hexyloxy)-1,4-phenylenevinylene)-alt-(1,3-phenylenevinylene)] and poly{[2-[2′,5′-bis(2″-ethylhexyloxy)phenyl]-1,4-phenylenevinylene]-co-[2-methoxy-5-(2′-ethylhexyloxy)-1,4-phenylenevinylene]}; polythiophene polymers and copolymers selected from regiostatistic poly(3-butylthiophene-2,5-diyl), regioregular poly(3-butylthiophene-2,5-diyl), poly(3-cyclohexyl-4-methylthiophene-2,5-diyl), poly(3-cyclohexylthiophene-2,5-diyl), poly(3-decyloxythiophene-2,5-diyl) 0.5% (w/v) in tetrahydrofuran, regiostatistic poly(3-decylthiophene-2,5-diyl), regioregular poly(3-decylthiophene-2,5-diyl), M_{w}˜42,000, Mₙ˜30,000, regiostatistic poly(3-dodecylthiophene-2,5-diyl), regioregular poly(3-dodecylthiophene-2,5-diyl), M_{w}˜162,000, regiostatistic poly(3-hexylthiophene-2,5-diyl), regioregular poly(3-hexylthiophene-2,5-diyl), regiostatistic poly(3-octylthiophene-2,5-diyl), regioregular poly(3-octylthiophene-2,5-diyl), poly(3-octylthiophene-2,5-diyl-co-3-decyloxythiophene-2,5-diyl), poly(thiophene-2,5-diyl) bromine terminated powder, poly[(2,5-didecyloxy-1,4-phenylene)-alt-(2,5-thienylene)]; and water-soluble LEPs selected from poly(2,5-bis(3-sulphonatepropoxy)-1,4-phenylene, (disodium salt-alt-1,4-phenylene), poly[(2,5-bis{2-{N,N-diethylamonium)ethoxy)-1,4-phenylene)-alt-1,4-phenylene] bromide, poly[5-methoxy-2-(3-sulphopropoxy)-1,4-phenylenevinylene] 0.25% by weight potassium salt solution in H₂O and poly{[2,5-bis(2-(N,N-diethylamine)ethoxy)-1,4-phenylene]-alt-1,4-phenylene}.

The luminescent organic crystals are light-emitting and dopant crystals. These compounds are selected from 5,12-dihydro-5,12-dimethylquine[2,3-b]acridine-7,14-dione, 8-hydroxyquinoline zinc 99%, anthracene sublimed grade ≧99%, anthracene zone-refined ≧99%, benz[b]anthracene 98%, benz[b]anthracene sublimed grade 99.99% trace metal basis, coumarin 6≧99%, dichlorotris(1,10-phenanthroline)ruthenium(II) hydrate 98%, lithium tetra(2-methyl-8-hydroxyquinoline)boron 98%, perylene sublimed grade ≧99.5%, platinum octaethylporphyrin dye content 98%, rubrene sublimed grade, tris(2,2′-bipyridyl)dichlororutenium(II) hexahydrate 99.95% trace metal basis, tris(2,2′-bipyridyl-d8)ruthenium(II)hexafluorophosphate 95%, tris(benzoylacetonato) mono(phenanthroline)europium(III), tris(dibenzoylmethane) mono(1,10-phenanthroline)europium(III) sublimed grade 95%, tris(dibenzoylmethane) mono(5-amino-1,10-phenanthroline)europium(III), tris-(8-hydroxyquinoline)aluminium 99.995% trace metal basis, tris-(8-hydroxyquinoline)aluminium sublimed grade 99.995% trace metal basis, tris[1-phenylisoquinoline-C²,N]iridium(III) 90%, tris[1-phenylisoquinoline-C²,N]iridium(III) sublimed grade, tris[2-(4,6-difluorophenyl)pyridinate-C²,N]iridium (III) 96%, tris[2-(benzo[b]thiophen-2-yl)pyridinato-C³,N]iridium(III) 96%, tris[2-phenylpyridinato-C²,N]iridium(III) 99%, and tris[2-phenylpyridinato-C²,N]iridium(III) sublimed grade 96%.

Alternatively, alkaline earth metal aluminates or polifluorene can be used.

Depending on the specific product, earth metals can include strontium, magnesium, calcium and barium. Silicon and titanium can also be included. Europium is a typical dopant. The colors in the spectrum are in the range from yellowish green to purple-blue. The raw dye is pale and translucent.

A preferred compound is the [aluminium-tris(8-hydroxyquinoline)] (Alq3). The presence of Alq3 in the compound along with MEH-PPV causes the color to change from red to green. However, the use of different organic or inorganic crystals or dyes allows the production of labels which can change from red to other colors besides green.

Useful solvents for preparing solutions of electronic polymers, organic and inorganic crystals or dyes are selected from aromatic solvents, organic solvents and others, including toluene, chloroform, chlorobenzene, dichloromethane, tetrahydrofuran, o-xylol and CCl₄.

Useful for practicing the invention are fluorescent, phosphorescent and luminescent dyes of organic or inorganic origin.

The inert polymer matrix is selected from polystyrene (PS), methyl polymethacrylate (PMMA), poly(vinyl chloride) (PVC) and the like.

The researches of the applicant which gave birth to the present specification were developed using a luminescent polymer and an organic crystal, and it will be appreciated by those skilled in the art that the obtained results equally apply to all compounds mentioned above which show a similar behavior.

An especially useful luminescent polymer comprises poly[2-methoxy-5 (2′-ethyl-hexyloxy)-1,4-phenylenevinylene] (MEH-PPV).

An especially useful organic crystal comprises tris[aluminium(8-hydroxyquinoline)] (Alq3).

Both compounds are usually employed in green and orange LEDs. The choice of such compounds as color indicators in labels for blue-light radiation is based in that they are extremely susceptible to photooxidation processes which change dramatically the color and photoemission spectra thereof. The rate of such variations can be equally changed for the manipulation of organic solutions and oxygen enrichment.

Poly(2-methoxy,5-ethyl(2-hexyloxy)-p-phenylenevinylene) (MEH-PPV). MEH-PPV is a soluble conjugated polymer derived from poly(p-phenylenevinylene) (PPV) which has the molecular formula (C₁₈H₂₈O₂)ₙ, the chemical structure of which is represented in the formula below:

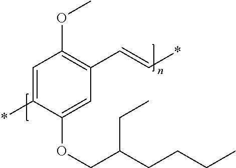

In the above formula, it can be noted that the main polymer chain of MEH-PPV is composed of C—C and C═C alternative bonds which provide this polymer with the electronic properties of organic semiconductors. Such properties are associated to the fact that the main chain of such compounds is composed of sp2-hybridized carbon atoms, that is, carbon atoms in which an s orbital bonds to two p orbitals, thus forming three sp2-hybrid orbitals.

According to the manufacturer specifications, the MEH-PPV (CAS No. 138184-36-8) used in the researches of the applicant which led to the present application has a mean molar mass (Mₙ) from 70.000 to 100.000 g/mol and absorption and emission maximums at wavelengths about 495 nm and 555 nm, respectively, when solubilized in toluene. This polymer has also good solubility in other organic solvents, such as chloroform and xylene, which allows the production of thin and ultra-thin films from this material by means of simple inexpensive techniques, such as spin coating, casting and ink jet printing.

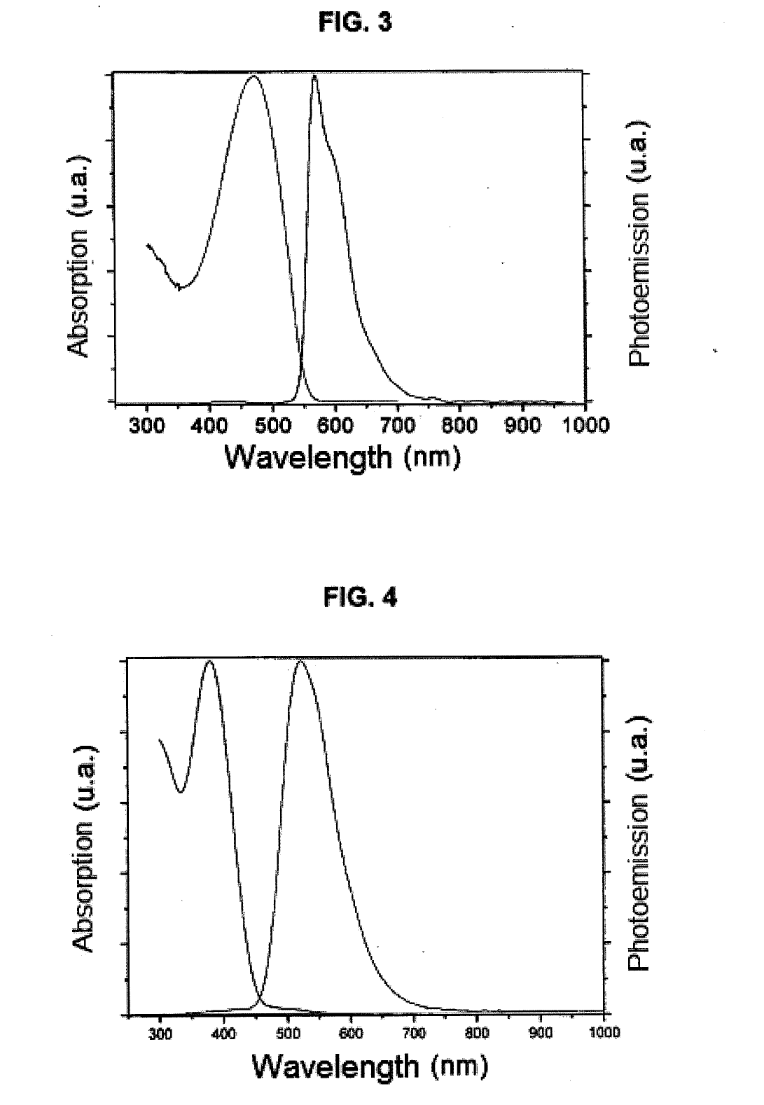

In FIG. 3, it can also be noted that MEH-PPV dissolved in chloroform has absorption and emission maximums about 475 nm and 570 nm, respectively.

When exposed to non-ionising radiation, especially blue light, the absorption and emission spectra of MEH-PPV change their shapes and intensities mainly due to the photooxidation effects of the main polymer chain of this polymer. The main result from such effects is the reduction in intensity and the displacements of the spectra to smaller wavelengths. This effect is critical in order to develop labels as radiation sensors since it allows to associate the color and intensity of emission of the polymer with the radiation dose which it was exposed to.

Alq3 is a conjugated organic compound also known as 8-hydroxyquinoline aluminium salt, molecular formula C₂₇H₁₈AlNO₃, the chemical structure of which is shown in the formula below.

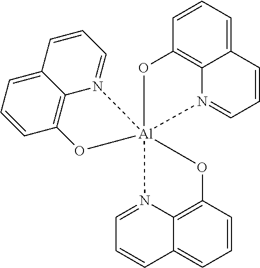

In the above formula, it can be noted that the Alq3 molecule has three quinolinate groups bonded to the aluminium atom by means of N—Al and O—Al bonds. The Alq3 used in the researches which led to the development of the present application was commercially obtained from Sigma-Aldrich and, according to the specifications provided by the manufacturer (CAS No. 2085-33), it has a molecular mass of 459.3 g/mol and a purity of 99.995%. Such material is often used as an emitting layer (green radiation) or as an electron-transport layer in OLEDs and other organic light displays. According to the literature, when processed as films by evaporation techniques, the Alq3 has wavelengths of maximum absorption and emission about 375 nm and 480 nm, respectively. The good solubilization of such material in chloroform can be experimentally verified.

FIG. 4 shows the absorption spectrum in the UV-VIS region and the photoemission spectrum of an Alq3 solution (500 μg/mL) in chloroform.

In FIG. 4, it can also be noted that the Alq3 dissolved in chloroform has absorption and emission maximums about 400 nm and 550 nm, respectively. When Alq3 is exposed to radiation, its absorption and emission spectra experience degradation effects due to the presence of light and oxygen and/or water. However, unlike MEH-PPV, the emission and absorption spectra of Alq3 do not experience displacements for smaller wavelengths due to radiation exposure, thus experiencing reduction only in the intensities thereof.

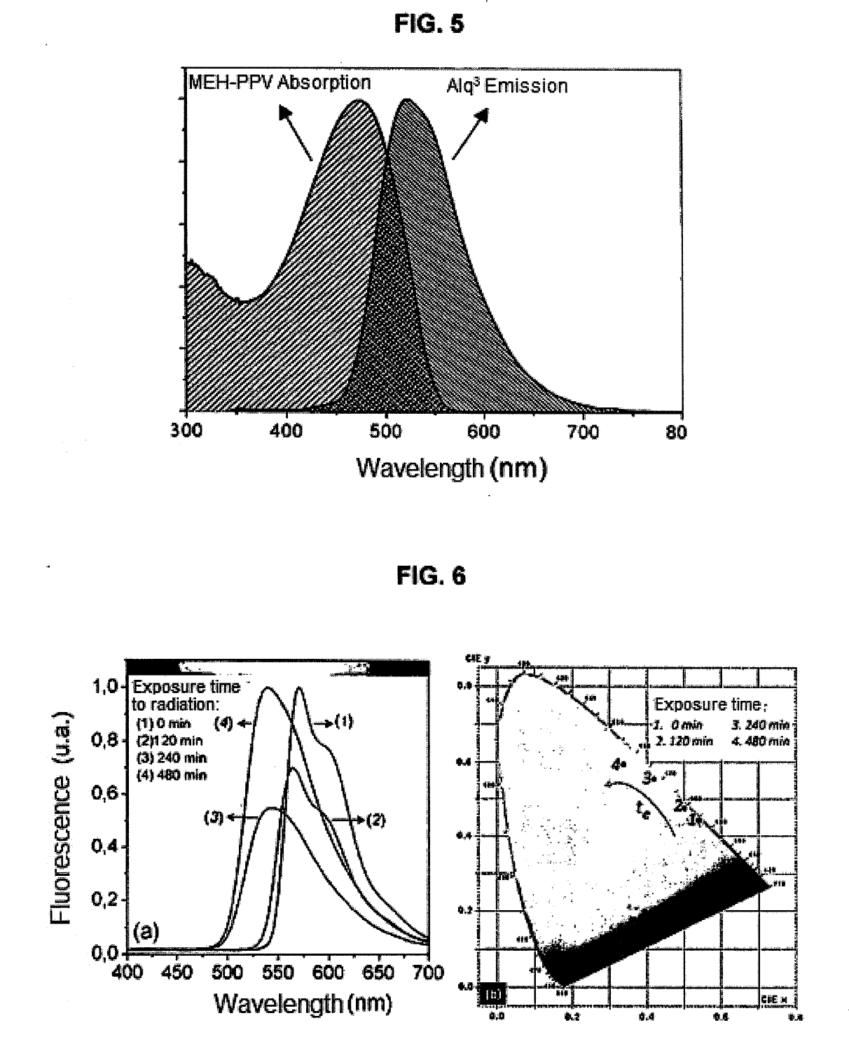

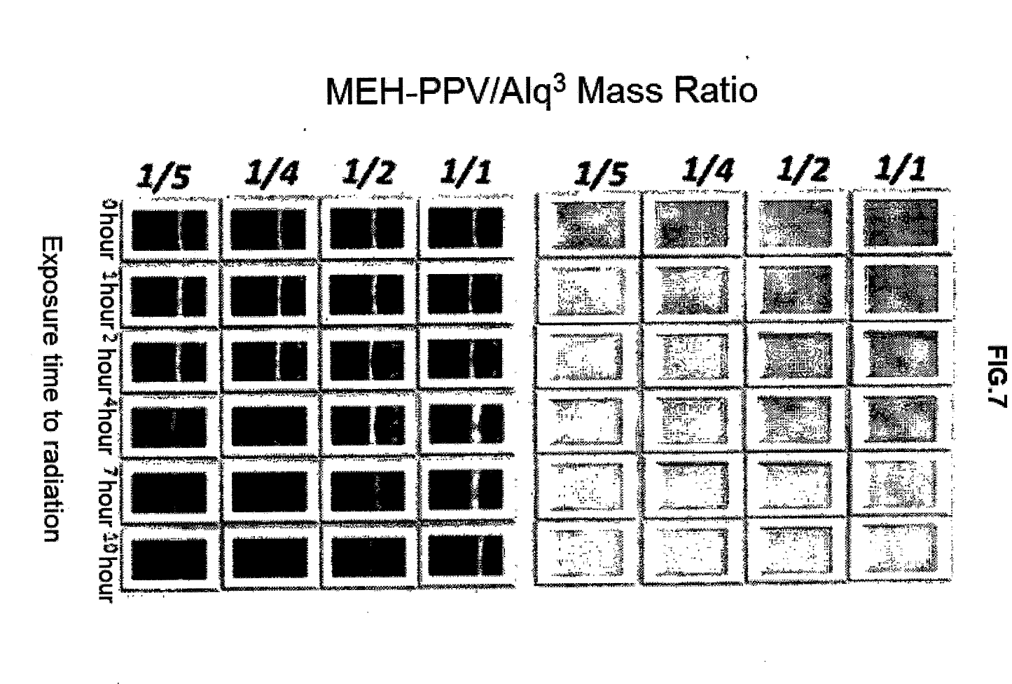

Just like the absorption spectrum of MEH-PPV (FIG. 3) and the emission spectrum of Alq3 (FIG. 4) overlap in the region from 450 to 550 nm showed in FIG. 5, and considering both solubility in chloroform, as well as the evolution in shape and intensity of these spectra due to radiation, a mixture of these two materials and their optical characterization are possible aiming specially at the application of these system in radiation sensors. This feature explains why both organic compounds, Alq3 and MEH-PPV, are used in the present research.

Therefore, the present process differs from the object of application PI 07004907, given this last dosimeter uses only MEH-PPV. The difference between using a MEH-PPV emitter and both MEH-PPV and Alq3 emitters according to the present invention is that the first dosimeter, based only on MEH-PPV, changes its color from red to orange and, then, to yellow. On the other hand, the dosimeter of the present invention, combining MEH-PPV and Alq3, or any combination of electronic polymers and organic crystals mentioned above, and designated as an intelligent label or seal, operates as a smart device, like an optical key, which changes from red to green. This change results from the combination of the absorption and emission spectra of both materials, MEH-PPV and Alq3.

The combination of MEH-PPV with Alq3 operates this way:

1. Time zero (non-radiated samples): MEH and Alq3 absorb radiation in the blue range and emit radiation in the red and green range, respectively. However, the emission from Alq3 is absorbed by MEH-PPV and the final fluorescence result is that of MEH-PPV.

2. After exposure to radiation, the absorption spectrum of MEH-PPV changes to blue and reduces its intensity. As a result, the light intensity absorbed by Alq3 is reduced.

3. After certain time (or radiation dose), which can be controlled by changing the mass compositions of MEH-PPV/Alq3, oxygen enrichment, addition of inhibitors or accelerators etc., the ABS spectrum of MEH-PPV moves so much to blue that the emission from Alq3 is not absorbed by this polymer any more. Thus, the label or solution begins to emit in the green range.

In view of the relatively costly (˜R$ 30.00/cm²) production of thin films based only on these two materials, the combination of MEH-PPV and Alq3 materials with a low-cost, transparent, chloroform-soluble and non-toxic engineering polymer, which can be used as the matrix for the luminescent materials, is proposed. The examples are constructed with polystyrene (PS), although, as mentioned above, other inert polymers, such as PVC, PPMA etc., can be used.

Preparation of Luminescent Organic Films and Solutions

In order to produce the labels, solutions of Alq3 and MEH-PPV in chloroform are initially prepared at different concentrations, since the optical properties of both materials depend both on the concentration of the solutions and also on the exposure time to non-ionising radiation (visible). Thus, labels useful as sensors based on MEH-PPV/Alq3 solutions and PS/MEH-PPV/Alq3 films are produced by varying the amount of the materials in each sample.

After preparing and characterizing these solutions, flexible films are made using MEH-PPV and Alq3 compounds in PS matrix by means of the casting method.

The preparation process of all the materials and devices is described below.

Treatment of the Solvent

Chloroform, having a purity of 99.8%, commercially available from Synth is used as solvent both for the MEH-PPV and for the Alq3. The choice of this solvent is made based on the results shown in the literature related to the solubility of MEH-PPV in solvents with different polarities.

Preparation of PS/MEH-PPV/Alq3 Films

In order to produce luminescent films, polystyrene solutions in chloroform at a concentration of 1 mg/mL to 1 g/mL are prepared. 50 mL of this solution are mixed with 5 mL of solutions of MEH-PPV (500 μg/mL) and Alq3 (1000 μg/mL) in order to obtain self-sustaining films of these systems by the method of casting onto glass substrate.

The main advantage of this method is its simplicity and the possibility of obtaining uniform films with varying thickness.

For the deposition of the films, the polymer solution is spread over glass slides with the aid of a pipette and, then, the solvent is eliminated by evaporation, resulting in the formation of a film of the desired material.

The amount of films formed strongly depends on parameters such as temperature, heating rate, solution/solvent ratio.

The entire process for obtaining films is carried out in the absence of light in order to prevent the materials from degrading. The optical and structural characterization of the luminescent compounds and their respective radiation sensors prepared and used throughout the present research is determined by measures of: (i) chromaticity, for determining color (XYZ scale); (ii) photoemission and absorption spectroscopy in the visible region, for obtaining the electronic spectra; and (iii) gel permeation chromatography, infrared absorption spectroscopy and mass spectroscopy, for the structural characterization of the materials.

In order to investigate the viability of the organic system disclosed in the present application as an active element for the accumulation of blue-light radiation dose, the evolution in both reflected and emitted color changes is monitored by the blue-light radiation of MEH-PPV and Alq3 solutions and of these two compounds in PS matrix. Thus, pictures of the organic systems are obtained for different exposure times of the same to radiation. Then, a color table is designed, which correlate color with radiation exposure time and can be compared to a set of solutions, similarly to a pH indicator.

In order to optimize the label or dosimeter, the color change is also analyzed by means of a chromaticity diagram.

Finally, films of the materials are prepared and formed into self-adhesive labels for direct application in jaundiced newborns or other applications.

The results obtained are provided below.

In order to develop the prototype of the organic dosimeter, the pictures are arranged as a color table as shown in FIG. 7.

In the diagrams shown in FIG. 7, each X coordinate represents the time of exposure to radiation of studied solutions having different mass ratios of MEH-PPV/Alq3, from 1/1 to 1/5 MEH-PPV/Alq3. In this case, the accuracy of the measure of absorbed radiation by the polymer would not be related to the comparison of a single point in the table, which could generate a subjective reading of the color, but instead of 8 points, 4 of them referring to the reflected color and 4 of them referring to the emitted color. This dosimeter is easy to ready and brings reliability to the sensor response.

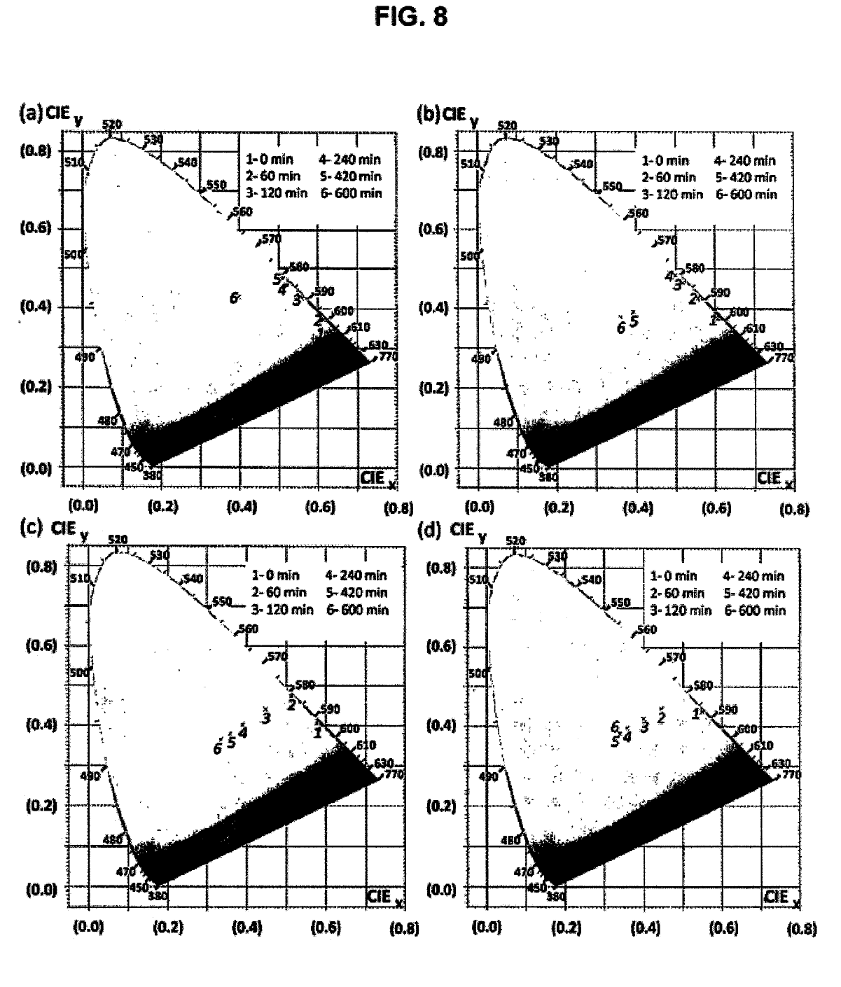

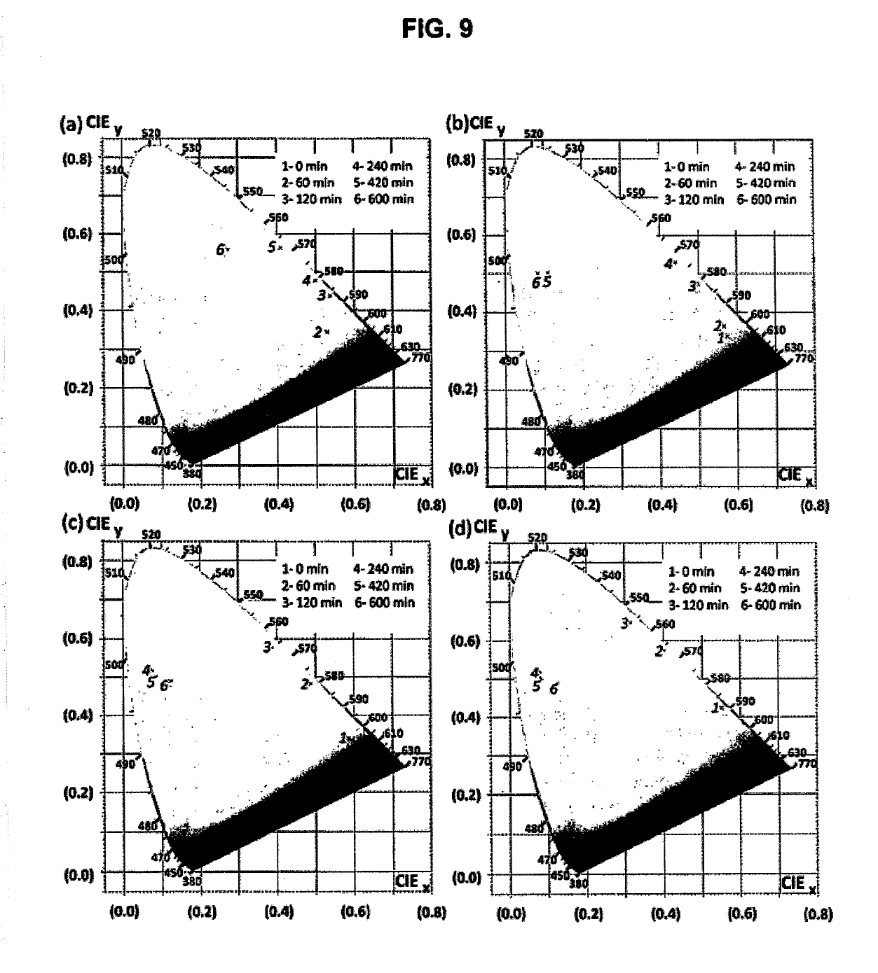

In order to illustrate the occurred color changes shown in FIG. 7, chromaticity diagrams are obtained, which show the changes in the reflected colors, see FIG. 8, and the changes in the emitted colors by the solutions, see FIG. 9.

. From the results shown in FIGS. 8 and 9, it can be noted that the transition regions from orange to light yellow in the reflected colors and from red to green in the emitted colors are controlled by simply manipulating the ratio of luminescent compounds in the solutions. In particular, the change in the emitted color, which is of greater interest for the phototherapy because the luminescent systems are exposed and excited throughout the phototherapy treatment, happens more quickly the smaller the relation between the amounts of MEH-PPV to Alq3. This color change can be controlled by varying te in the interval 1 h≦te≦8 h, where te is the exposure time of the system to radiation.

Such results are useful not only for designing a color table having different dose vs. color comparison points, but also for developing sensors wherein red light emission indicates the radiation time needed for the phototherapy treatment, specific to each neonate, or other kinds of exposure, not achieved yet, while the green light emission indicates that the radiation exposure was enough.

In the case of phototherapy for neonates, in order to provide higher security levels to newborns, the label or dosimeter is made as flexible films. To do so, PS/MEH-PPV/Alq3 films prepared according to the experimental procedure described herein above are used, and the changes in the optical properties thereof are observed when they are exposed to radiation.

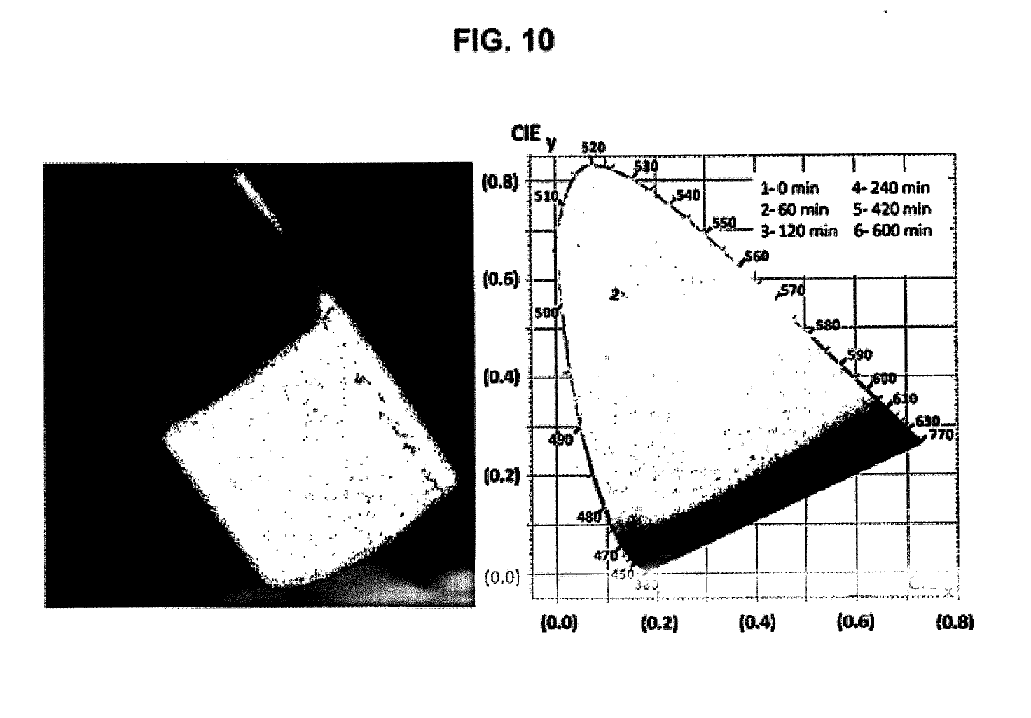

From the results shown in FIG. 10, it can be noted that the exposure of the films to blue-light radiation promotes a change in the emitted color of the films from red to green. It should also be noted that the film shows a change in the emitted color from red to green after 8 h of radiation, which is a time often used at hospitals in phototherapy treatments for carrying out blood tests in order to assess the serum bilirubin level.

However, films with the same change in the emitted color at different times can also be produced by simply varying the mass of MEH-PPV/Alq3 in PS. This is shown in FIG. 7.

With respect to cost, the label developed by the applicant is extremely interesting. Thus, the cost of a film with an area of 1 cm² does not exceed R$0.10 (about US$0.05.) These factors, along with the ease of fabrication and handling, show the application potential of the present label.

An electronic device (100, 200) according to the present invention, capable of indicating changes in color and emission of the polymer system by means of optical responses from the organic materials, comprises:

a) an excitation source (1) within the absorption range of the polymer(s) and organic or inorganic crystal or luminescent dye (2); and

c) at least one photodiode (3, 3a, 3b), or similar light-capturing devices, either having optical filters or not, selected within the range of the visible spectrum, including blue, green and red, capable of converting the light transmitted and emitted by the luminescent system by means of a microcontroller (4) in voltage, current and electrical resistance, whereby it is possible to correlate the optical changes of said luminescent materials (2) with the radiation dose absorbed by means of a computer or display (5).

Generally, the source (1) is a blue or purple commercial LED. The photodiode(s) (3, 3a, 3b), the microcontroller (4) and the computer or display (5) are commercial electroeletronic components, as well as the connections intended to interconnect the various components to each other in order to obtain the desired information from the system.

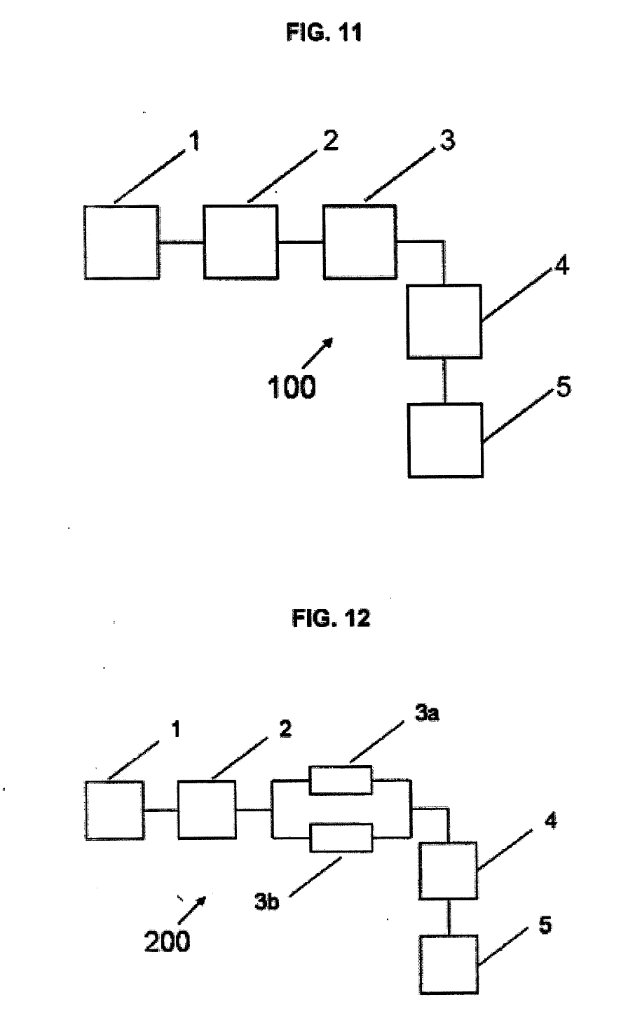

FIGS. 11 and 12 schematically show two configurations of the electronic device of the present invention.

FIG. 11 shows a configuration of the device of the present invention comprising a photodiode (3), while FIG. 12 shows a configuration of the same device provided with two photodiodes (3a, 3b).

1-59. (canceled)

60. A method for producing a label based on conjugated polymers for monitoring radiation doses, said method being characterized for comprising the following steps:
a) in the absence of light and at room temperature, mixing solutions, in an organic solvent, of i) an electronic polymer (1-2000 μg/ml) and at least one organic crystal, inorganic crystal or luminescent dye (1-2000 μg/ml), or ii) a combination of electronic polymers (1-2000 μg/ml), thereby obtaining solutions of said luminescent materials;
b) pouring the solutions of (a) on glass substrates in order to obtain self-sustaining films by the casting method;
c) vaporizing the solvent; and
d) separating and retrieving the intelligent label as a luminescent film.

61. The method, according to claim 60, characterized for alternatively comprising initially preparing solutions of inert polymer matrix in an organic solvent at a concentration of at least 1 μg/mL to 50 mg/mL; combining said solutions of inert polymer matrix in a volumetric ratio from 5:1 to 50:1 with the solutions of 1) an electronic polymer (1-2000 μg/mL) and at least one organic crystal, inorganic crystal or luminescent dye (1-2000 μg/mL), or ii) a combination of electronic polymers (1-2000 μg/mL); pouring the solutions on a glass substrate; vaporizing the solvent; and retrieving the intelligent label as a luminescent film ready for various applications.

62. The method, according to claim 60, characterized by the fact that the luminescent polymer is a light-emitting polymer (LEP).

63. The method, according to claim 60, characterized by the fact that the organic and inorganic luminescent crystals are light-emitting and dopant crystals.

64. The method, according to claim 60, characterized by the fact that the dye is selected from fluorescent, phosphorescent and luminescent dyes of organic and inorganic origin.

65. The method, according to claim 60, characterized in that the organic solvent is a chlorinated aromatic or organic solvent selected from toluene, chloroform, chlorobenzene, dichloromethane, tetrahydrofuran, o-xylol and CCl₄.

66. The method, according to claim 61, characterized in that the inert polymer matrix comprises polystyrene, poly(vinyl chloride) (PVC), methyl polymethacrylate (PPMA) and the like.

67. A method, according to claim 60, characterized by comprising, optionally, the step of moving the solutions obtained in the step a) to glass ampoules either amphoterically sealed or not, keeping them away from light, stocking in ampoules.

68. The method, according to claim 62, characterized by the fact that the light-emitting polymer (LEP) is selected of the group consisting in cyano-polyphenylene vinylene (CN-PPV) polymers selected from poly(2,5-di(hexyloxy)cyanoterephthalylidene, poly(2,5-di(octyloxy)cyanoterephthalylidene), poly(2,5-di(3,7-dimethyloctyloxy)cyanoterephthalylidene, poly(5-(2-ethylhexyloxy)-2-methoxy-cyanoterephthalylidene); nitrogenated polymers selected from poly(2,5-pyridine) and poly(3,5-pyridine); poly(fluorenylene-ethynylene) (PFE) polymers selected from poly(9,9-dioctylfluorenyl-2,7-ylene-ethynylene), poly[9,9-di(3′,7′-dimethyloctyl)fluoren-2,7-ylene-ethynylene], poly[9,9-di(2′-ethylhexyl)fluoren-2,7-ylene-ethynylene], poly[9,9-d]dodecylfluoroenyl-2,7-ylene-ethylnylene]; poly(phenylene-ethynylene) (PPE) polymers selected from poly(2,5-di(3′,7′-dimethyloctyl)phenylene-1-ethynylene), poly(2,5-dicyclohexylphenylene-1,4-ethynylene), poly(2,5-di(2′-ethylhexyl)-1,4-ethynylene), poly(2,5-didodecylphenylene-1,4-ethynylene) and poly(2,5-dioctylphenylene-1,4-ethynylene); polyfluorene (PFO) polymers and copolymers selected from poly(9,9-di-n-dodecylfluorenyl-2,7-diyl), poly(9,9-di-n-hexylfluorenyl-2,7-diyl), poly(9,9-di-n-octylfluorenyl-2,7-diyl), poly(9,9-n-dihexyl-2,7-fluorene-alt-9-phenyl-3,6-carbazole), poly[(9,9-di-n-octylfluorenyl-2,7-diyl)-alt-(benzo[2,1,3]thiadiazole-4,8-diyl)], poly[(9,9-dihexylfluoren-2,7-diyl)-alt-(2,5-dimethyl-1,4-phenylene)], poly[(9,9-dihexylfluoren-2,7-diyl)-co-(9-ethylcarbazole-2,7-diyl)], poly[(9,9-dihexylfluoren-2-diyl)-co-(antracen-9,10-diyl)], poly[(9,9-dioctylfluorenyl-2,7-diyl)-co-bithiophene] 99%, poly[9,9-bis-(2-ethylhexyl)-9H-fluorene-2,7-diyl]; polyfluorene-vinylene (PFV) copolymers selected from poly((9,9-dihexyl-9H-fluorene-2,7-vinylene)-co-(1-methoxy-4-(2-ethylhexyloxy)-2,5-phenylenevinylene)), 90:10 molar ratio, poly((9,9-dihexyl-9H-fluorene-2,7-vinylene)-co-(1-methoxy-4-(2-ethylhexyloxy)-2,5-phenylenevinylene)), 95:5 molar ratio, poly(9,9-di-(2-ethylhexyl)-9H-fluorene-2,7-vinylene), poly(5-di-n-hexylfluorenyl-2,7-vinylene), poly[(9,9-di-(2-ethylhexyl)-9H-fluorene-2,7-vinylene)-co-(1-methoxy-4-(2-ethylhexyloxy)-2,5-phenylenevinylene)] (90:10 molar ratio), poly[(9,9-di-(2-ethyl hexyl)-9H-fluorene-2,7-vinyl ene)-co-(1-methoxy-4-(2-ethyl hexyloxy)-2,5-phenylenevinylene)] (95:5 molar ratio), poly[9-(2-ethylhexyl)-3,6-carbazolevinylene-alt-2,6-naphtalenevinylene; polyphenylenevinylene (PPV) polymers and copolymers selected from poly(1-methoxy-4-(3-propyloxy-heptaisobutyl-PSS)-2,5-phenylenevinylene)-co-(1-methoxy-4-(2-ethylhexyloxy)-2,5-phenylenevinylene) (60:40), poly(1-methoxy-4-(O-disperse red))-2,5-phenylenevinylene, poly(2,5-bis(1,4,7,10-tetraoxaundecyl)-1,4-phenylenevinylene), poly(2,5-dihexyloxy-1,4-phenylenevinylene), poly(2,5-dioctyl-1,4-phenylenevinylene), poly(2,6-naphtalenevinylene), poly(p-xylene tetrahydrothiophenium) chloride as a 0.25% by weight solution in H₂O, film of poly(p-xylene tetrahydrothiophenium) chloride, poly[(m-phenylenevinylene)-alt-(2,5-dyhexyloxy-p-phenylenevinylene)], poly[(m-phenylenevinylene)-alt-(2-methoxy-5-(2-ethyl hexyloxy)-p-phenylenevinylene)], poly[(m-phenylenevinylene)-alt-(2-methoxy-5-octyloxy-p-phenylenevinylene)], poly[(m-phenylenevinylene)-co-(2,5-dioctoxy-p-phenylenevinylene)], poly[(o-phenylenevinylene)-alt-(2-methoxy-5-(2-ethylhexyloxy)-p-phenylenevinylene)], poly[(p-phenylenevinylene)-alt-(2-methoxy-5-(2-ethylhexyloxy)-p-phenylenevinylene)], poly[1-methoxy-4-(3-propyloxy-heptaisobutyl-PSS)-2,5-phenylenevinylene], poly[1-methoxy-4-(3-propyloxy-heptaisobutyl-PSS)-2,5-phenylenevinylene]-co-[1-methoxy-4-(2-ethylhexyloxy)-2,5-phenylenevinylene] (30:70), poly[2,5bis(3′,7′-dimethyloctyloxy)-1,4-phenylenevinylene], poly[2,5-bisoctyloxy)-1,4-phenylenevinylene], poly[2-(2′,5′-bis(2″-ethylhexyloxy)phenyl)-1,4-phenylenevinylene], poly[2-methoxy-5-(2-ethylhexyloxy)-1,4-phenylenevinylene] Mₙ 150,000-250,000, poly[2-methoxy-5-(2-ethylhexyloxy)-1,4-phenylenevinylene] Mₙ 40,000-70,000, poly[2-methoxy-5-(2-ethylhexyloxy)-1,4-phenylenevinylene] Mₙ 70,000-100,000, potassium salt as a 0.25% by weight solution in H₂O of poly[2-methoxy-5-(3′,7′-dimethyloctyloxy)-1,4-phenylenevinylene], potassium salt in a solution of poly[5-methoxy-2-(3-sulfopropoxy)-1,4-phenylenevinylene], poly[tris(2,5-bis(hexyloxy)-1,4-phenylenevinylene)-alt-(1,3-phenylenevinylene)] and poly{[2-[2′,5′-bis(2″-ethylhexyloxy)phenyl]-1,4-phenylenevinylene]-co-[2-methoxy-5-(2′-ethylhexyloxy)-1,4-phenylenevinylene]}, polythiophene polymers and copolymers selected from regiostatistic poly(3-butylthiophene-2,5-diyl), regioregular poly(3-butylthiophene-2,5-diyl), poly(3-cyclohexyl-4-methylthiophene-2,5-diyl), poly(3-cyclohexylthiophene-2,5-diyl), poly(3-decyloxythiophene-2,5-diyl) 0.5% (w/v) in tetrahydrofuran, regiostatistic poly(3-decylthiophene-2,5-diyl), regioregular poly(3-decylthiophene-2,5-diyl), M_{w}˜42,000, Mₙ˜30,000, regiostatistic poly(3-dodecylthiophene-2,5-diyl), regioregular poly(3-dodecylthiophene-2,5-diyl), M_{w}˜162,000, regiostatistic poly(3-hexylthiophene-2,5-diyl), regioregular poly(3-hexylthiophene-2,5-diyl), regiostatistic poly(3-octylthiophene-2,5-diyl), regioregular poly(3-octylthiophene-2,5-diyl), poly(3-octylthiophene-2,5-diyl-co-3-decyloxythiophene-2,5-diyl), poly(thiophene-2,5-diyl) bromine terminated powder, poly[(2,5-didecyloxy-1,4-phenylene)-alt-(2,5-thienylene)]; and water-soluble LEPs selected from poly(2,5-bis(3-sulphonatepropoxy)-1,4-phenylene, (disodium salt-aft-1,4-phenylene), poly[(2,5-bis{2-{N,N-diethylamonium)ethoxy)-1,4-phenylene)-alt-1,4-phenylene] bromide, poly[5-methoxy-2-(3-sulphopropoxy)-1,4-phenylenevinylene] 0.25% by weight potassium salt solution in H₂O and poly{[2,5-bis(2-(N,N-diethylamine)ethoxy)-1,4-phenylene]-alt-1,4-phenylene} or mixtures thereof.

69. The method, according to claim 68, characterized by the fact that the luminescent polymer is a polyphenylenevinylene (PPV) selected from poly(2-methoxy, 5-ethyl(2-hexyloxy)-p-phenylenevinylene) (MEH-PPV).

70. The method, according to claim 62, characterized by the fact that the organic or inorganic crystals or dyes are selected from the group consisting in: 5,12-dihydro-5,12-dimethylquine[2,3-b]acridine-7,14-dione, 8-hydroxyquinoline zinc 99%, anthracene sublimed grade ≧99%, anthracene zone-refined ≧99%, benz[b]anthracene 98%, benz[b]anthracene sublimed grade 99% trace metal basis, coumarin 6≧99%, dichlorotris(1,10-phenanthroline)ruthenium(II) hydrate 98%, lithium tetra(2-methyl-8-hydroxyquinoline)boron 98%, perylene sublimed grade ≧99.5%, platinum octaethylporphyrin dye content 98%, rubrene sublimed grade, tris(2,2′-bipyridyl)dichlororutenium(II) hexahydrate 99.95% trace metal basis, tris(2,2′-bipyridyl-d8)ruthenium(II)hexafluorophosphate 95%, tris(benzoylacetonato) mono(phenanthroline)europium(III), tris(dibenzoylmethane) mono(1,10-phenanthroline)europium(III) sublimed grade 95%, tris(dibenzoylmethane) mono(5-amino-1,10-phenanthroline)europium(III), tris-(8-hydroxyquinoline)aluminium 99.995% trace metal basis, tris-(8-hydroxyquinoline)aluminium sublimed grade 99.995% trace metal basis, tris[1-phenylisoquinoline-C²,N]iridium(III) 90%, tris[1-phenylisoquinoline-C²,N]iridium(III) sublimed grade, tris[2-(4-difluorophenyl)pyridinate-C²,N]iridium (III) 96%, tris[2-(benzo[b]thiophen-2-yl)pyridinato-C²,N]iridium(III) 96%, tris[2-phenylpyridinato-C²,N]iridium(III) 99%, and tris[2-phenylpyridinato-C²,N]iridium(III) sublimed grade 96%, alkaline earth metal aluminates including strontium, magnesium, calcium and barium; silicon and titanium; europium and polyfluorenes, or mixtures thereof.

71. The method, according to claim 70, characterized in that the organic crystal is [aluminium-tris(8-hydroxyquinoline)] (Alq3).

72. Composition of an inert polymer matrix and conjugated polymers for obtaining an intelligent label as a luminescent film by means of the method of claim 60, said composition being characterized for comprising:
a) 0% to 99.9% by weight of an inert polymer matrix in an organic solvent at a concentration of at least 1 μg/mL to 10 mg/mL, said matrix being combined in volumetric ratio from 5:1 to 50:1 to
b) a combination of solutions in an organic solvent comprising i) 0.1% to 99.9% by weight of an electronic polymer and at least 0.1% to 99.9% by weight of an organic, inorganic crystal or luminescent dye or ii) a combination in any ratio of two electronic polymers, provided that the degradation rates of the same due to radiation and/or the emission bands of both polymers are different.

73. Composition, according to claim 72, characterized by the fact that the organic solvent is a chlorinated organic or aromatic solvent selected from toluene, chloroform, chlorobenzene, dichloromethane, tetrahydrofuran, o-xylol and CCl₄.

74. Composition, according to claim 72, characterized by the fact that the inert polymer matrix comprises polystyrene, poly(vinyl chloride) (PVC), methyl polymethacrylate (PPMA).

75. Composition, according to claim 72, characterized by the fact that the luminescent polymer is a light-emitting polymer (LEP).

76. Composition, according to claim 72, characterized by the fact that the organic luminescent crystals are light-emitting and dopant crystals.

77. Composition, according to claim 72, characterized by the fact that the dye is selected from fluorescent, phosphorescent and luminescent dyes of organic and inorganic origin.

78. Composition, according to claim 75, characterized by the fact that the light-emitting polymer (LEP) is selected from the group consisting in: cyano-polyphenylene vinylene (CN-PPV) polymers selected from poly(2,5-di(hexyloxy)cyanoterephthalylidene, poly(2,5-di(octyloxy)cyanoterephthalylidene), poly(2,5-di(3,7dimethyloctyloxy)cyanoterephthalylidene, poly(5-(2-ethylhexyloxy)-2-methoxy-cyanoterephthalylidene); nitrogenated polymers selected from poly(2,5-pyridine) and poly(3,5-pyridine); poly(fluorenylene-ethynylene) (PFE) polymers selected from poly(9,9-dioctylfluorenyl-2,7-ylene-ethynylene), poly[9,9-di(3′,7′-dimethyloctyl)fluoren-2,7-ylene-ethynylene], poly[9,9-di(2′-ethylhexyl)fluoren-2,7-ylene-ethynylene], poly[9,9-didodecylfluoroenyl-2,7-ylene-ethylnylene]; poly(phenylene-ethynylene) (PPE) polymers selected from poly(2,5-di(3′,7′-dimethyloctyl)phenylene-1-ethynylene), poly(2,5-dicyclohexylphenylene-1,4-ethynylene), poly(2,5-di(2′-ethylhexyl)-1,4-ethynylene), poly(2,5-didodecylphenylene-1,4-ethynylene) and poly(2,5-dioctylphenylene-1,4-ethynylene); polyfluorene (PFO) polymers and copolymers selected from poly(9,9-di-n-dodecylfluorenyl-2,7-diyl), poly(9,9-di-n-hexylfluorenyl-2,7-diyl), poly(9,9-di-n-octylfluorenyl-2,7-diyl), poly(9,9-n-dihexyl-2,7-fluorene-alt-9-phenyl-3,6-carbazole), poly[(9,9-di-n-octylfluorenyl-2,7-diyl)-alt-(benzo[2,1,3]thiadiazole-4,8-diyl)], poly[(9,9-dihexylfluoren-2,7-diyl)-alt-(2,5-dimethyl-1,4-phenylene)], poly[(9,9-dihexylfluoren-2,7-diyl)-co-(9-ethylcarbazole-2,7-diyl)], poly[(9,9-dihexylfluoren-2-diyl)-co-(antracen-9,10-diyl)], poly[(9,9-dioctylfluorenyl-2,7-diyl)-co-bithiophene] 99%, poly[9,9-bis-(2-ethylhexyl)-9H-fluorene-2,7-diyl]; polyfluorene-vinylene (PFV) copolymers selected from poly((9,9-dihexyl-9H-fluorene-2,7-vinylene)-co-(1-methoxy-4-(2-ethylhexyloxy)-2,5-phenylenevinylene)), 90:10 molar ratio, poly((9,9-dihexyl-9H-fluorene-2,7-vinylene)-co-(1-methoxy-4-(2-ethylhexyloxy)-2,5-phenylenevinylene)), 95:5 molar ratio, poly(9,9-di-(2-ethylhexyl)-9H-fluorene-2,7-vinylene), poly(5-di-n-hexylfluorenyl-2,7-vinylene), poly[(9,9-di-(2-ethylhexyl)-9H-fluorene-2,7-vinylene)-co-(1-methoxy-4-(2-ethylhexyloxy)-2,5-phenylenevinylene)] (90:10 molar ratio), poly[(9,9-di-(2-ethyl hexyl)-9H-fluorene-2,7-vinyl ene)-co-(1-methoxy-4-(2-ethyl hexyloxy)-2,5-phenylenevinylene)] (95:5 molar ratio), poly[9-(2-ethylhexyl)-3,6-carbazolevinylene-alt-2,6-naphtalenevinylene; polyphenylenevinylene (PPV) polymers and copolymers selected from poly(1-methoxy-4-(3-propyloxy-heptaisobutyl-PSS)-2,5-phenylenevinylene)-co-(1-methoxy-4-(2-ethylhexyloxy)-2,5-phenylenevinylene) (60:40), poly(1-methoxy-4-(O-disperse red))-2,5-phenylenevinylene, poly(2,5-bis(1,4,7,10-tetraoxaundecyl)-1,4-phenylenevinylene), poly(2,5-dihexyloxy-1,4-phenylenevinylene), poly(2,5-dioctyl-1,4-phenylenevinylene), poly(2,6-naphtalenevinylene), poly(p-xylene tetrahydrothiophenium) chloride as a 0.25% by weight solution in H₂O, film of poly(p-xylene tetrahydrothiophenium) chloride, poly[(m-phenylenevinylene)-alt-(2,5-dyhexyloxy-p-phenylenevinylene)], poly[(m-phenylenevinylene)-alt-(2-methoxy-5-(2-ethyl hexyloxy)-p-phenylenevinylene)], poly[(m-phenylenevinylene)-alt-(2-methoxy-5-octyloxy-p-phenylenevinylene)], poly[(m-phenylenevinylene)-co-(2,5-dioctoxy-p-phenylenevinylene)], poly[(o-phenylenevinylene)-alt-(2-methoxy-5-(2-ethylhexyloxy)-p-phenylenevinylene)], poly[(p-phenylenevinylene)-alt-(2-methoxy-5-(2-ethylhexyloxy)-p-phenylenevinylene)], poly[1-methoxy-4-(3-propyloxy-heptaisobutyl-PSS)-2,5-phenylenevinylene], poly[1-methoxy-4-(3-propyloxy-heptaisobutyl-PSS)-2,5-phenylenevinylene]-co-[1-methoxy-4-(2-ethylhexyloxy)-2,5-phenylenevinylene] (30:70), poly[2,5bis(3′,7′-dimethyloctyloxy)-1,4-phenylenevinylene], poly[2,5-bisoctyloxy)-1,4-phenylenevinylene], poly[2-(2′,5′-bis(2″-ethylhexyloxy)phenyl)-1,4-phenylenevinylene], poly[2-methoxy-5-(2-ethylhexyloxy)-1,4-phenylenevinylene] Mₙ 150,000-250,000, poly[2-methoxy-5-(2-ethylhexyloxy)-1,4-phenylenevinylene] Mₙ 40,000-70,000, poly[2-methoxy-5-(2-ethylhexyloxy)-1,4-phenylenevinylene] Mₙ 70,000-100,000, potassium salt as a 0.25% by weight solution in H₂O of poly[2-methoxy-5-(3′,7′-dimethyloctyloxy)-1,4-phenylenevinylene], potassium salt in a solution of poly[5-methoxy-2-(3-sulfopropoxy)-1,4-phenylenevinylene], poly[tris(2,5-bis(hexyloxy)-1,4-phenylenevinylene)-alt-(1,3-phenylenevinylene)] and poly{[2-[2′,5′-bis(2″-ethylhexyloxy)phenyl]-1,4-phenylenevinylene]-co-[2-methoxy-5-(2′-ethylhexyloxy)-1,4-phenylenevinylene]}, polythiophene polymers and copolymers selected from regiostatistic poly(3-butylthiophene-2,5-diyl), regioregular poly(3-butylthiophene-2,5-diyl), poly(3-cyclohexyl-4-methylthiophene-2,5-diyl), poly(3-cyclohexylthiophene-2,5-diyl), poly(3-decyloxythiophene-2,5-diyl) 0.5% (w/v) in tetrahydrofuran, regiostatistic poly(3-decylthiophene-2,5-diyl), regioregular poly(3-decylthiophene-2,5-diyl), M_{w}˜42,000, Mₙ˜30,000, regiostatistic poly(3-dodecylthiophene-2,5-diyl), regioregular poly(3-dodecylthiophene-2,5-diyl), M_{w}˜162,000, regiostatistic poly(3-hexylthiophene-2,5-diyl), regioregular poly(3-hexylthiophene-2,5-diyl), regiostatistic poly(3-octylthiophene-2,5-diyl), regioregular poly(3-octylthiophene-2,5-diyl), poly(3-octylthiophene-2,5-diyl-co-3-decyloxythiophene-2,5-diyl), poly(thiophene-2,5-diyl) bromine terminated powder, poly[(2,5-didecyloxy-1,4-phenylene)-alt-(2,5-thienylene)]; and water-soluble LEPs selected from poly(2,5-bis(3-sulphonatepropoxy)-1,4-phenylene, (disodium salt-aft-1,4-phenylene), poly[(2,5-bis{2-{N,N-diethylamonium)ethoxy)-1,4-phenylene)-alt-1,4-phenylene] bromide, poly[5-methoxy-2-(3-sulphopropoxy)-1,4-phenylenevinylene] 0.25% by weight potassium salt solution in H₂O and poly{[2,5-bis(2-(N,N-diethylamine)ethoxy)-1,4-phenylene]-alt-1,4-phenylene}, or mixtures thereof.

79. Composition, according to claim 78, characterized by the fact that said luminescent polymer is a polyphenylenevinylene (PPV) selected from poly(2-methoxy, 5-ethyl(2-hexyloxy)-p-phenylenevinylene) (MEH-PPV).

80. Composition, according to claim 76, characterized by the fact that the organic or inorganic crystals or dyes are selected from the group consisting in: 5,12-dihydro-5,12-dimethylquine[2,3-b]acridine-7,14-dione, 8-hydroxyquinoline zinc 99%, anthracene sublimed grade ≧99%, anthracene zone-refined ≧99%, benz[b]anthracene 98%, benz[b]anthracene sublimed grade 99.99% trace metal basis, coumarin 6≧99%, dichlorotris(1,10-phenanthroline)ruthenium(II) hydrate 98%, lithium tetra(2-methyl-8-hydroxyquinoline)boron 98%, perylene sublimed grade ≧99.5%, platinum octaethylporphyrin dye content 98%, rubrene sublimed grade, tris(2,2′-bipyridyl)dichlororutenium(II) hexahydrate 99.95% trace metal basis, tris(2,2′-bipyridyl-d8)ruthenium(II)hexafluorophosphate 95%, tris(benzoylacetonato) mono(phenanthroline)europium(III), tris(dibenzoylmethane) mono(1,10-phenanthroline)europium(III) sublimed grade 95%, tris(dibenzoylmethane) mono(5-amino-1,10-phenanthroline)europium(III), tris-(8-hydroxyquinoline)aluminium 99.995% trace metal basis, tris-(8-hydroxyquinoline)aluminium sublimed grade 99.995% trace metal basis, tris[1-phenylisoquinoline-C²,N]iridium(III) 90%, tris[1-phenylisoquinoline-C²,N]iridium(III) sublimed grade, tris[2-(4-difluorophenyl)pyridinate-C²,N]iridium (III) 96%, tris[2-(benzo[b]thiophen-2-yl)pyridinato-C³,N]iridium(III) 96%, tris[2-phenylpyridinato-C²,N]iridium(III) 99%, and tris[2-phenylpyridinato-C²,N]iridium(III) sublimed grade 96%, alkaline earth metal aluminates including strontium, magnesium, calcium and barium; silicon and titanium; europium and polyfluorenes, or mixtures thereof.

81. Composition, according to claim 80, characterized in that the organic crystal is selected from [aluminium-tris(8-hydroxyquinoline)] (Alq3).

82. A label for monitoring radiation doses, said label being characterized for being obtained by the method of claim 60 and comprises a composition.

83. The method for measuring incident radiation, characterized for exposing the product to radiation and monitoring the color and the absorption, photoemission and photoexcitation spectra of the same or of the structural changes due to the radiation dose delivered to the individuals, newborns or oncologic patients.

84. The method, according to claim 83, characterized by the fact that the radiation is a non-ionising radiation such as in a phototherapy.

85. The method, according to claim 83, characterized by the fact that the radiation is an ionising radiation, including X-rays, gamma rays, beta rays and electron beams.

86. The method, according to claim 83, characterized by comprising the exposure of a flexible film product to said ionising radiations, such as in a radiation therapy, and monitoring the color and the absorption, photoemission and photoexcitation spectra of said film or of the structural changes due to the delivered radiation dose in order to calibrate the therapeutic beams according to said dose.

87. The method, according to claim 83, characterized by comprising the exposure of a flexible film product to ionising radiation employed in food in order to pasteurizing products, sterilizing products and delaying the ripening process of fruits and vegetables, and monitoring the color and the absorption, photoemission and photoexcitation spectra of said film or of the structural changes due to the delivered radiation dose.

88. The method, according to claim 83, characterized by the fact that the radiation is an ultraviolet radiation (UV).

89. The method, according to claim 88, characterized for comprising the exposure of the flexible film product to said UV radiations employed for sanitary and phytosanitary purposes, and monitoring the color and the absorption, photoemission and photoexcitation spectra of said film or of the structural changes due to the delivered radiation dose.

90. The solution in ampoules for monitoring radiation doses, said solution being characterized for being obtained by the method step as defined on claim 67.

91. The solution, according to claim 90, characterized for exposing said solution in ampoules to radiation and monitoring the color and the absorption, photoemission and photoexcitation spectra of the same or of the structural changes due to the radiation dose delivered to individuals, newborns or oncologic patients.

92. The solution, according to claim 91, characterized in that the radiation is a non-ionising radiation such as in a phototherapy.

93. The solution, according to claim 92, characterized in that the radiation is an ionising radiation, including X-rays, gamma rays, beta rays and electron beams.

94. The solution, according to claim 93, characterized for exposing said solution in ampoules to said ionising radiations used in radiation therapy and monitoring the color and the absorption, photoemission and photoexcitation spectra of said solution in ampoules or of the structural changes due to the delivered radiation dose in order to calibrate the therapeutic beams according to said dose.

95. The solution, according to claim 94, characterized for exposing said solution in ampoules to ionising radiation employed in food in order to pasteurizing products, sterilizing products and delaying the ripening process of fruits and vegetables, and monitoring the color and the absorption, photoemission and photoexcitation spectra of said solution or of the structural changes due to the delivered radiation dose.

96. The solution, according to claim 91, characterized in that the radiation is an ultraviolet radiation (UV).

97. The solution, according to claim 96, characterized for exposing said solution in ampoules to said UV radiations employed for sanitary and phytosanitary purposes, and monitoring the color and the absorption, photoemission and photoexcitation spectra of said solution or of the structural changes due to the delivered radiation dose.

98. A use of a label obtained by the method of claim 60, said use being characterized for comprising monitoring individuals exposed to ionising radiation for therapeutic purposes.

99. The use, according to claim 98, characterized by the fact that it is in the calibrating therapeutic beams, including X rays, gamma rays, beta rays and electron beams, used in radiation therapy.

100. The use, according to claim 98, characterized for comprising monitoring non-ionising radiation in neonates submitted to phototherapy for treating hyperbilirubinemia.

101. The use, according to claim 100, characterized for comprising fixing the said label close to the newborn, in diapers, eye patches and the like, by means of a double sided self-adhesive strip in order to assess the effective dose or equivalent radiation dose in a given time period.

102. The use, according to claim 99, characterized for comprising monitoring foods and flowers exposed to ionising radiation for sanitary, phytosanitary and/or technological purposes.

103. The use, according to claim 98, characterized for comprising monitoring the radiation derived from sunless tanning machines.

104. The use, according to claim 98, characterized for comprising monitoring the radiation equipment intended for treating vitiligo.

105. The use, according to claim 98, characterized for comprising monitoring soldiers and civil or rural workers exposed to solar radiation during short or long time periods.

106. The use, according to claim 98, characterized for comprising monitoring soldiers and civil or rural workers exposed to ultraviolet radiation (UV) during short or long time periods.

107. The use of solutions in ampoules obtained by the method of claim 67, said use being characterized for comprising monitoring individuals exposed to ionising radiation for therapeutic purposes.

108. The use, according to claim 107, characterized for calibrating therapeutic beams, including X-rays, gamma rays, beta rays and electron beams, used in radiation therapy.

109. The use, according to claim 107, characterized for comprising monitoring non-ionising radiation in neonates submitted to phototherapy for treating hyperbilirubinemia.

110. The use, according to claim 107, characterized for comprising monitoring the radiation derived from sunless tanning machines.

111. The use, according to claim 107, characterized for comprising monitoring the radiation equipment intended for treating vitiligo.

112. The use, according to claim 107, characterized for comprising monitoring soldiers and civil or rural workers exposed to solar radiation during short or long time periods.

113. The use, according to claim 107, characterized for comprising monitoring foods and flowers exposed to ionising radiation for sanitary, phytosanitary and/or technological purposes.

114. An electronic device (100, 200) for indicating changes in color and emission in a system of polymers and luminescent crystals or dyes as described in claim 60 by means of the optical responses of the organic materials, said electronic device being characterized for comprising:
a) an excitation source (1) selected from the group consisting in LED (light-emitting diodes), lasers, and lamps, whose emission spectrum is located within the absorption range of the polymer(s) and organic or inorganic crystal or luminescent dye (2); and
b) at least one light-capturing device (3, 3a, 3b), within the range of the visible spectrum, selected from a group consisting in photodiodes, phototransistors, and photovoltaic cells, capable of converting the light transmitted and emitted by said system of polymers and crystals or dyes by means of a microcontroller (4) in voltage, current and electrical resistance, whereby it is possible to correlate the optical changes in said luminescent materials (2) to the radiation dose absorbed by means of a computer or display (5).

115. The device, according to claim 114, characterized in that the source (1) is selected from a blue or purple LED (light-emitting diode).

116. The device, according to claim 114, characterized in that said light-capturing device (3, 3a, 3b) is selected from a photodiode or similar device.

117. Device, according to claim 114, characterized in that said photodiode or similar device is additionally provided with optical filter
